(19) United States
(12) Patent Application Publication
(10) Pub. No.: US 2010/0109276 A1
(43) Pub. Date: May 6, 2010

(54) CONTROLLABLE VEHICLE SUSPENSION SYSTEM WITH MAGNETO-RHEOLOGICAL FLUID DEVICE

(76) Inventors: ROBERT H. MARJORAM, Holly Springs, NC (US); Stephen F. Hildebrand, Apex, NC (US); Douglas E. Ivers, Cary, NC (US); Gregory Ericksen, Cary, NC (US); William J. McMahon, Chapel Hill, NC (US); Kenneth A. St. Clair, Cary, NC (US)

Correspondence Address: LORD CORPORATION;PATENT & LEGAL SERVICES, 111 LORD DRIVE, P.O. Box 8012, CARY, NC, 27512-8012, US

(21) Appl. No.: 12/610,690

(22) Filed: Nov. 2, 2009

Related U.S. Application Data
(63) Continuation-in-part of application No. 11/742,911, filed on May 1, 2007.
Application No. 11/742,911 is a continuation-in-part of application No. PCT/US07/83937, filed on Nov. 7, 2007.
(60) Provisional application No. 60/796,567, filed on May 1, 2006.
(60) Provisional application No. 60/984,212, filed on Oct. 31, 2007.

(51) Int. Cl. B60G 11/46; B60G 17/018; B23P 17/00

(52) U.S. Cl. 280/124.157; 280/124.158; 29/890.09

(57) ABSTRACT

A controllable suspension system for controlling the relative motion between a first body and a second body includes at least one strut including a magneto-rheological fluid damper. The fluid damper includes a piston rod guide disposed within a damper body. The piston rod guide has a passage therein for receiving a piston rod. A piston rod bearing assembly is disposed in the piston rod guide to engage with and support reciprocal motion of the piston rod. At least a first piston rod seal and at least a second piston rod seal are arranged to seal between the piston rod guide and the piston rod. A fluid chamber is defined between the piston rod guide and the piston rod. A piston rod guide gas charged accumulator is arranged between the piston rod and the damper body.

### CROSS REFERENCE

This application is a continuation-in-part of application Ser. No. 11/742,911, filed May 1, 2007, which claims the benefit of U.S. Provisional Application No. 60/796,567, filed May 1, 2006, all of which the benefit are claimed and are herein incorporated by reference. This application is a continuation-in-part of International Application No. PCT/US07/83937, filed Nov. 7, 2007, which claims the benefit of U.S. Provisional Application No. 60/984,212, filed Oct. 31, 2007, and application Ser. No. 11/742,911, filed May 1, 2007, all of which the benefit are claimed and are herein incorporated by reference.

### FIELD OF THE INVENTION

The invention relates to the field of suspension systems for controlling motion. The invention relates to the field of controllable systems for controlling motion and providing support. The invention relates to the field of controllable vehicle systems for controlling vehicle motions. More particularly, the invention relates to vehicle cab suspensions with controllable magneto-rheological fluid device having beneficial motion control.

### BACKGROUND OF THE INVENTION

Magneto-rheological fluid devices such as magneto-rheological fluid dampers and struts are useful in controlling or damping motion in suspension systems such as vehicle suspension systems. A typical magneto-rheological fluid damper includes a damper body with a sliding piston rod received therein. The damper body includes a reservoir that is filled with magneto-rheological fluid, i.e., non-colloidal suspension of micron-sized magnetizable particles. One or more seals are used to retain the magneto-rheological fluid within the reservoir as the piston rod reciprocates within the damper body. The damping characteristics are controlled by applying a magnetic field to the magneto-rheological fluid. A magneto-rheological fluid strut combines a magneto-rheological fluid damper function with the ability to support loads.

There is a need for controllable magneto-rheological fluid devices for supporting a load while providing motion control and vibration isolation. There is a need for vehicle cab magneto-rheological fluid devices for isolating vibrations and cab motions. There is a need for controllable magneto-rheological fluid devices which accurately and economically control and minimize vibrations. There is a need for an economically feasible method of making motion control magneto-rheological fluid devices and vehicle suspension systems. There is a need for a robust suspension system and magneto-rheological fluid devices for isolating troublesome vibrations and controlling vehicle motions. There is a need for an economic suspension system providing beneficial controlled motion and vibration isolation.

### SUMMARY OF THE INVENTION

In one aspect, a controllable suspension system for controlling the relative motion between a first body and a second body includes at least one strut. The at least one strut includes a magneto-rheological fluid damper which comprises: a damper body; a piston rod guide disposed within the damper body, the piston rod guide having a passage therein for receiving a piston rod; a piston rod bearing assembly disposed in the piston rod guide to engage with and support reciprocal motion of the piston rod; at least a first piston rod seal and at least a second piston rod seal arranged to seal between the piston rod guide and the piston rod; a fluid chamber defined between the piston rod guide and the piston rod; and a piston rod guide gas charged accumulator arranged between the piston rod and the damper body.

In another aspect, a controllable suspension system for controlling the relative motion between a first body and a second body comprises: a damper body; a spring longitudinally aligned with the damper body; a piston rod guide disposed within the damper body, the piston rod guide having a passage therein for receiving a piston rod; a piston rod bearing assembly disposed in the piston rod guide to engage with and support reciprocal motion of the piston rod; at least a first piston rod seal and at least a second piston rod seal arranged to seal between the piston rod guide and the piston rod; a fluid chamber defined between the piston rod guide and the piston rod; and a piston rod guide gas charged accumulator arranged between the piston rod and the damper body.

In another aspect, a controllable suspension system for controlling the relative motion between a first body and a second body includes at least one strut. The at least one strut includes a magneto-rheological fluid damper which comprises: a damper body; a piston rod guide disposed within the damper body, the piston rod guide having a passage therein for receiving a piston rod; a piston rod bearing assembly disposed in the piston rod guide to engage with and support reciprocal motion of the piston rod; at least a first piston rod seal and at least a second piston rod seal arranged to seal between the piston rod guide and the piston rod; a fluid chamber defined between the piston rod guide and the piston rod; means for filtering fluid entering the fluid chamber; and a piston rod guide gas charged accumulator arranged between the piston rod and the damper body.

In another aspect, a method of making a controllable suspension system for controlling the relative motion between a first body and a second body comprises: providing a damper body having a reservoir for containing the magneto-rheological fluid; providing a piston rod; providing a piston rod guide disposed within the damper body, the piston rod guide having a passage therein for receiving the piston rod; providing a piston rod assembly coupled to the piston rod guide and arranged to engage and support reciprocal motion of the piston rod; providing at least a first piston rod seal and at least a piston rod seal arranged to seal between the piston rod guide and the piston rod; providing a fluid chamber defined between the piston rod guide and the piston rod; providing a piston rod guide filter arranged in a communication path between the fluid chamber and the reservoir to filter particulates out of fluid entering the fluid chamber; and providing an accumulator arranged between the piston rod guide and the damper body.

In another aspect, a controllable suspension system for controlling the relative motion between a first body and a second body includes at least one magneto-rheological fluid damper. The at least one magneto-rheological fluid damper comprises: a damper body; a piston rod guide disposed within the damper body, the piston rod guide having a passage therein for receiving a piston rod; a piston rod bearing assembly disposed in the piston rod guide to engage with and support reciprocal motion of the piston rod; at least a first piston rod seal and at least a second piston rod seal arranged to seal between the piston rod guide and the piston rod; and a piston rod guide gas charged accumulator arranged between the piston rod and the damper body. The magneto-rheological fluid damper includes a reservoir for a magneto-rheological fluid provided within the damper body and a piston rod guide filter arranged in a communication path between the fluid chamber and the reservoir to filter particulates out of the magneto-rheological fluid entering the fluid chamber from the reservoir.

In another aspect, a vehicle suspension system for controlling the relative motion between a first body and a second body comprises: a damper body; a spring longitudinally aligned with the damper body; a piston rod guide disposed within the damper body, the piston rod guide having a passage therein for receiving a piston rod; a piston rod bearing assembly disposed in the piston rod guide to engage with and support reciprocal motion of the piston rod; at least a first piston rod seal and at least a second piston rod seal arranged to seal between the piston rod guide and the piston rod; a fluid chamber defined between the piston rod guide and the piston rod; a piston rod guide gas charged accumulator, said piston rod guide gas charged accumulator arranged between the piston rod and the damper body; and a piston rod guide filter.

In another aspect, a method of controlling motion between a first body and a second body comprises: providing a magneto-rheological damper fluid comprised of a plurality of magnetic particulates in a carrier fluid; providing a damper body having a reservoir for containing the magneto-rheological fluid; providing a piston rod; providing a piston rod guide disposed within the damper body, the piston rod guide having a passage therein for receiving the piston rod; providing a piston rod assembly coupled to the piston rod guide and arranged to engage and support reciprocal motion of the piston rod; providing at an outer piston rod seal arranged to seal against the piston rod; providing a piston rod guide accumulator arranged between the piston rod and the damper body; and inhibiting the magnetic particulates from the magneto-rheological fluid in the reservoir from reaching the outer piston rod seal.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIG. 1 is a side view of a vehicle with a controllable suspension system including magneto-rheological fluid struts.

FIG. 2A is a side view of a tractor with a controllable suspension system including magneto-rheological fluid struts.

FIG. 2B is an end view of the tractor shown in FIG. 2A.

FIG. 3 is a diagram of a controllable suspension system including magneto-rheological fluid struts.

FIG. 4A is a side view of a magneto-rheological fluid strut including a magneto-rheological fluid damper.

FIG. 4B is an enlarged view of a portion of the magneto-rheological fluid strut shown in FIG. 4A.

FIG. 4C is another side view of the magneto-rheological fluid strut shown in FIG. 4A.

FIG. 4D is an end view of the magneto-rheological fluid strut shown in FIG. 4A.

FIG. 5 is a perspective view of a magneto-rheological fluid strut.

FIG. 6A is a side view of the magneto-rheological fluid strut shown in FIG. 5.

FIG. 6B is another side view of the magneto-rheological fluid strut shown in FIG. 5.

FIG. 6C is an end view of the magneto-rheological fluid strut shown in FIG. 5.

FIG. 6D is an end view of the magneto-rheological fluid strut shown in FIG. 5.

FIG. 6E is a side view of the magneto-rheological fluid strut shown in FIG. 5.

FIG. 6F is a cross-section of the magneto-rheological fluid strut shown in FIG. 6E.

FIG. 6G illustrates the relationship between piston rod bearing seal interface, bearing gap, piston head fluid flow interface, piston gap, and stroke length for the magneto-rheological fluid strut shown in FIG. 6F.

FIG. 6H is an enlarged view of a portion of the cross-section shown in FIG. 6G.

FIG. 6I is an enlarged view of a portion of a magneto-rheological fluid damper depicted in FIG. 6G, depicting an upper piston rod bearing assembly.

FIG. 6J is a perspective view of a head portion of the magneto-rheological fluid strut of FIG. 6G.

FIG. 6K is a perspective view of an end portion of the magneto-rheological fluid damper in the magneto-rheological fluid strut of FIG. 6G.

FIG. 6L is a perspective view of an electromagnetic coil included in the piston head of the magneto-rheological fluid damper of FIG. 6G.

FIG. 6M is a cross-section of the electromagnetic coil shown in FIG. 6L.

FIG. 6N is a perspective view of two overmolded EM coils.

FIG. 7A is an enlarged view of a piston head portion of the magneto-rheological fluid damper shown in FIG. 6G.

FIG. 7B is a perspective view of an overmolded EM coil.

FIGS. 7C through 7N are end, side, and cross-sectional views of portions or components of an overmolded EM coil.

FIG. 8 shows an arrangement of magneto-rheological fluid struts in a suspension system.

FIG. 9 is a cross-section of an EM coil.

FIG. 10 is a cross-section of a magneto-rheological fluid strut.

FIG. 11 is a perspective view of a magneto-rheological fluid damper.

FIGS. 12 and 13 depict vertical cross-section views of the magneto-rheological fluid damper of FIG. 11.

FIGS. 14-16 depict a partial cross-section of the magneto-rheological fluid damper of FIG. 11.

FIG. 17 is a schematic illustration of a vehicle with a suspension system including magneto-rheological fluid dampers.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

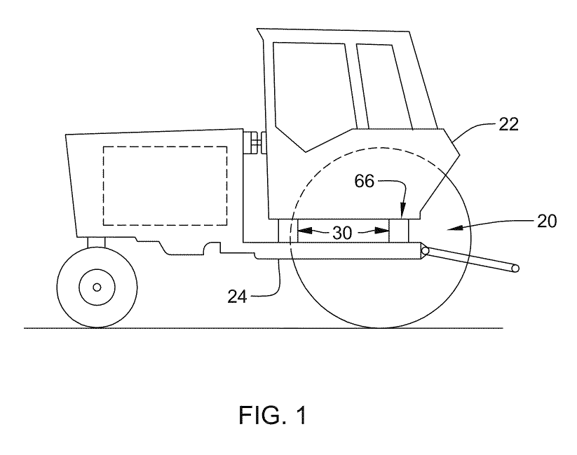

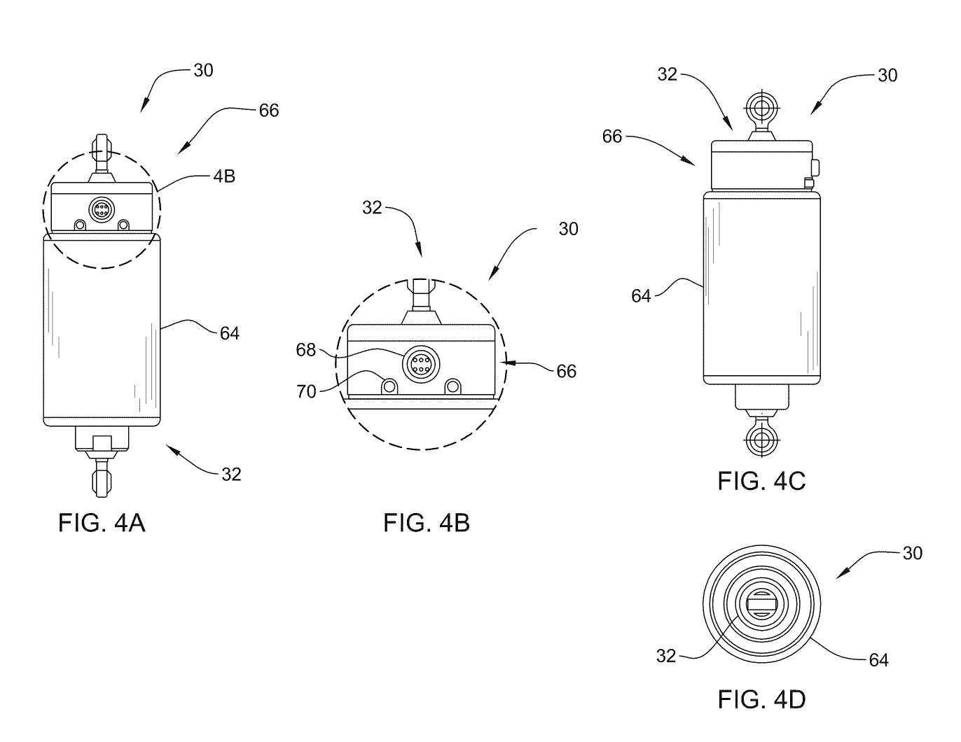

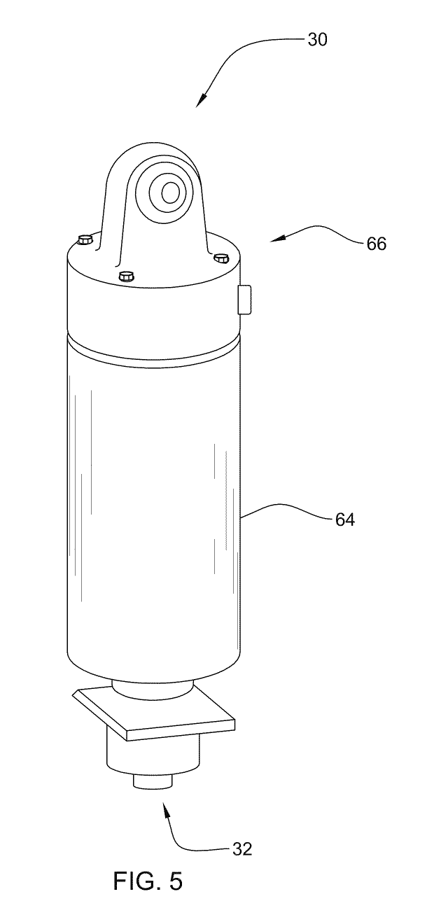

In an embodiment the invention includes a controllable suspension system for controlling the relative motion between a first body and a second body. Referring to FIGS. 1-10, and particularly to FIGS. 1-3, a controllable suspension system 20 controls the relative motion between a first body 22 and a second body 24. In preferred embodiments the controllable suspension system 20 is a vehicle controllable suspension system 20, most preferably as shown in FIGS. 1-3 a cab suspension controllable suspension system 20, with the suspension system controlling motion between the vehicle cab body 22 and the vehicle frame body 24. In alternative embodiments the controllable suspension system 20 is a non-vehicle suspension system, preferably a stationary suspension system.

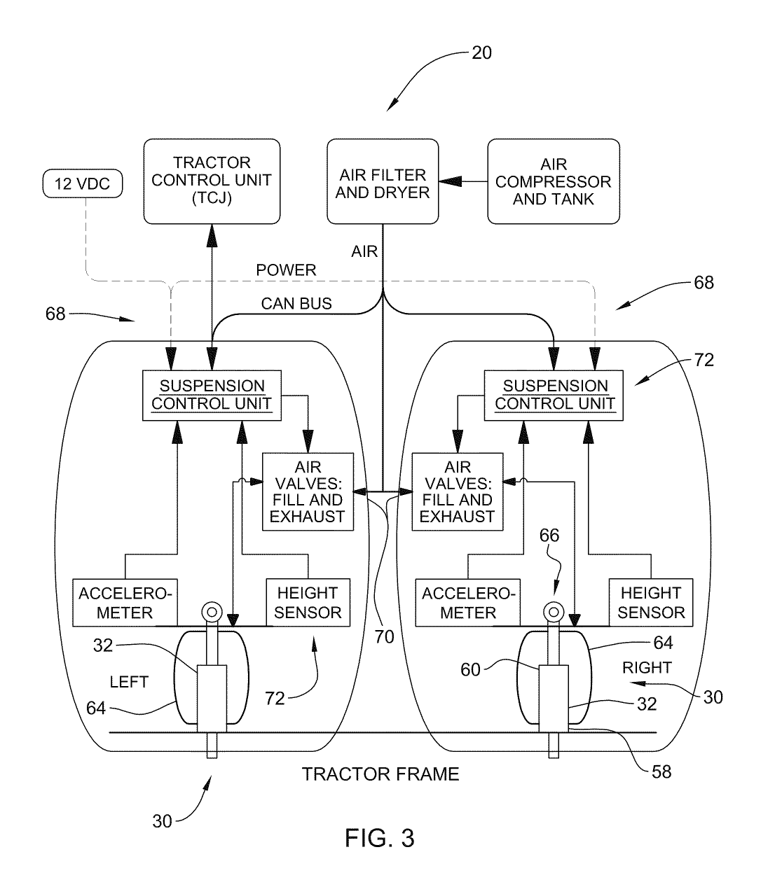

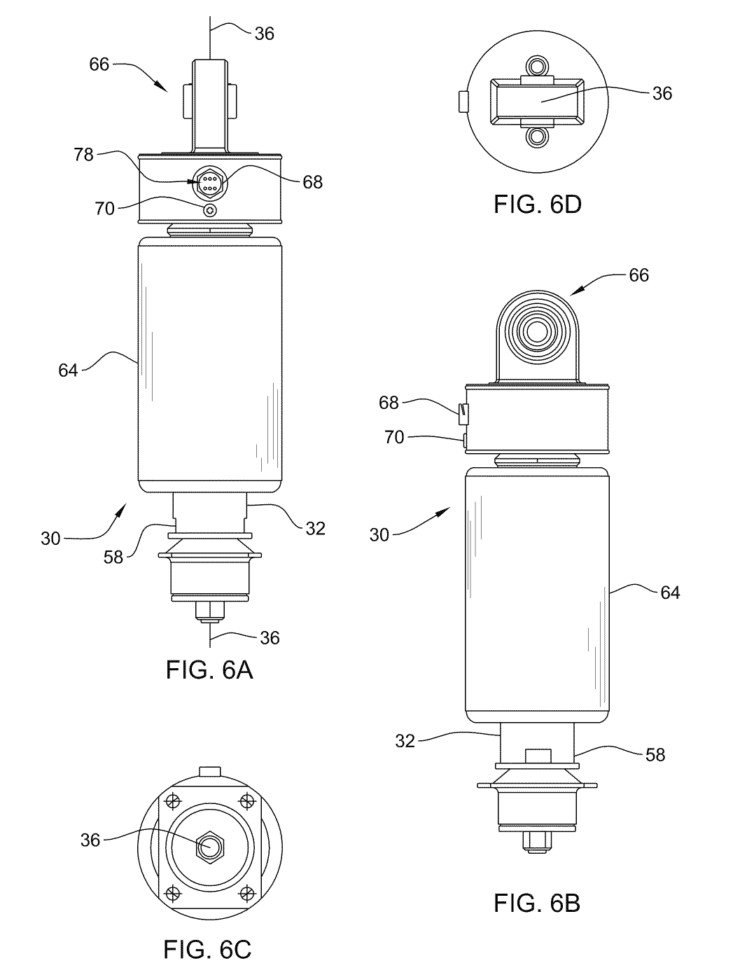

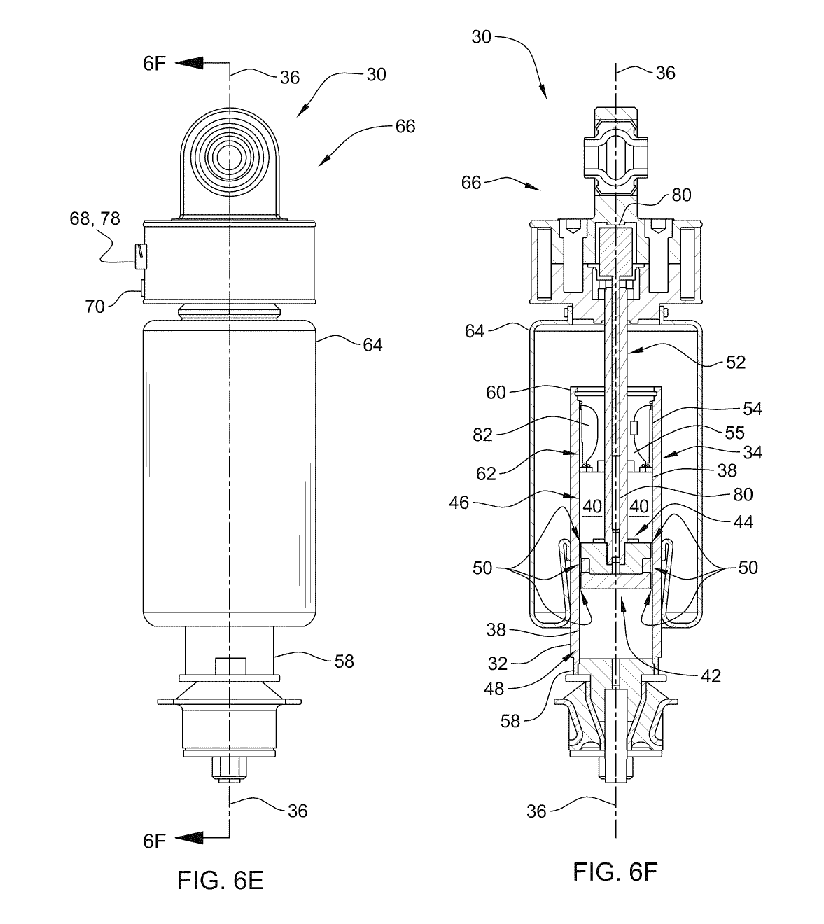

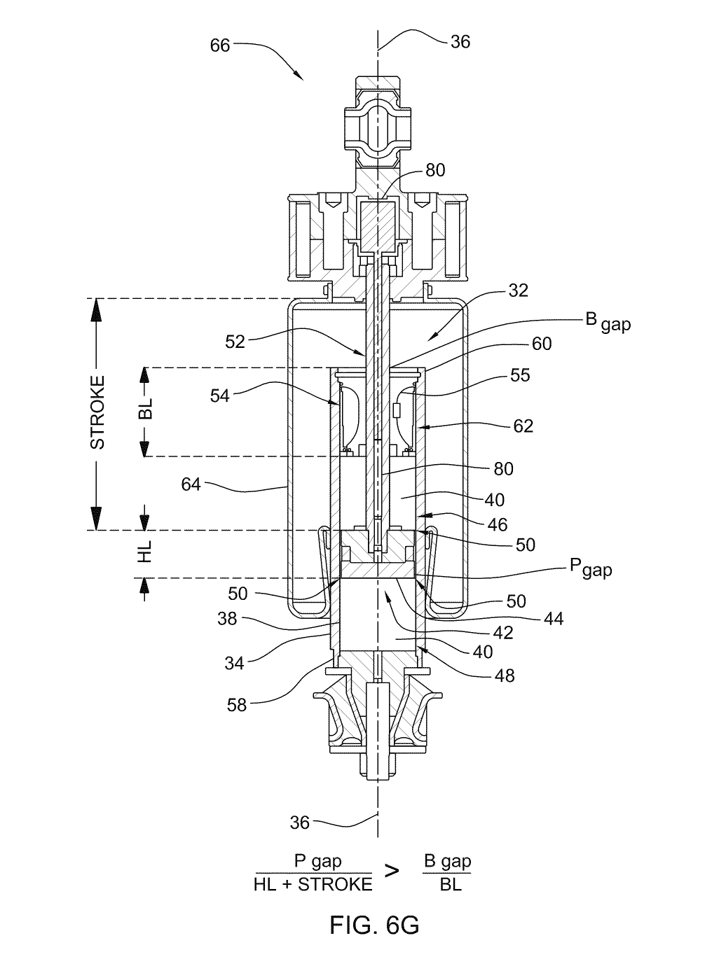

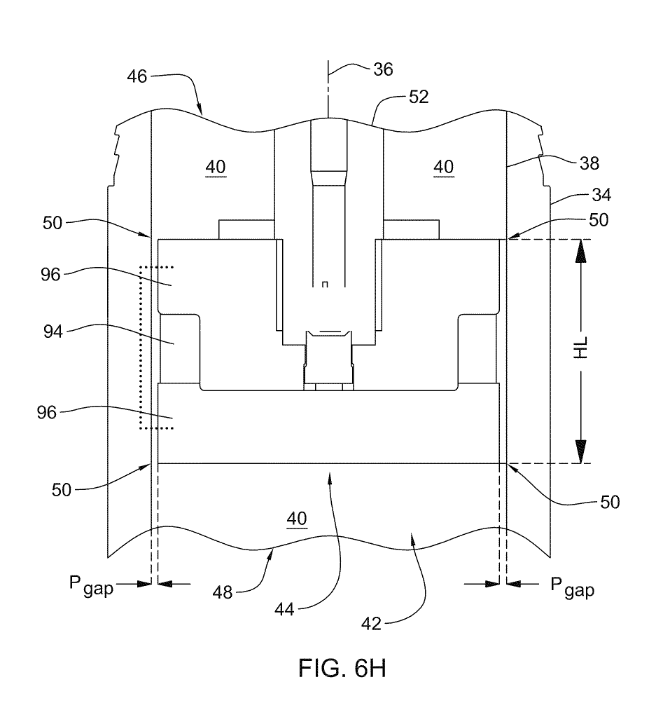

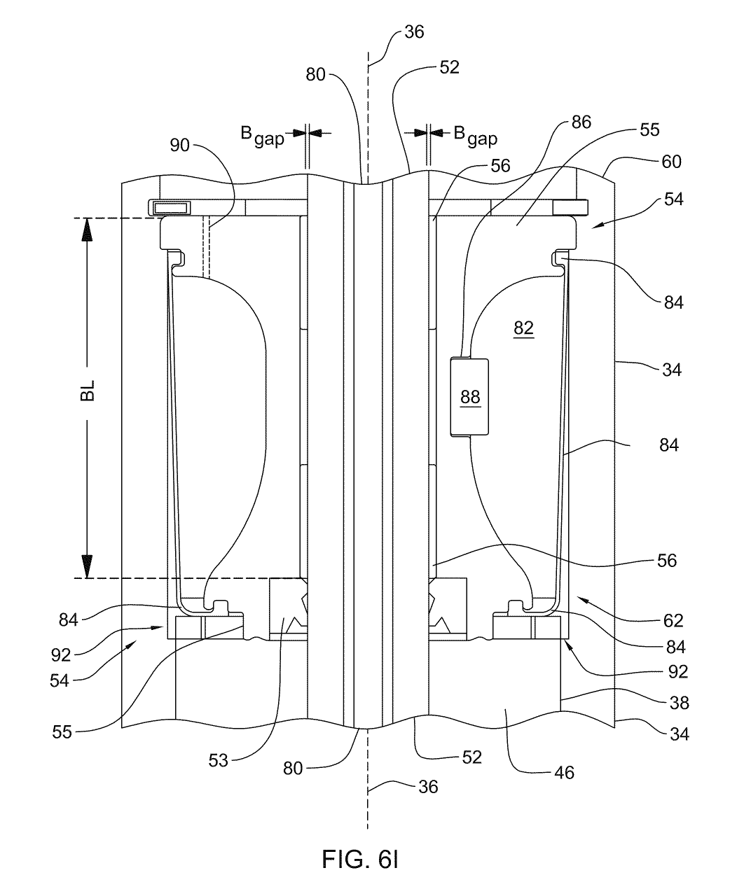

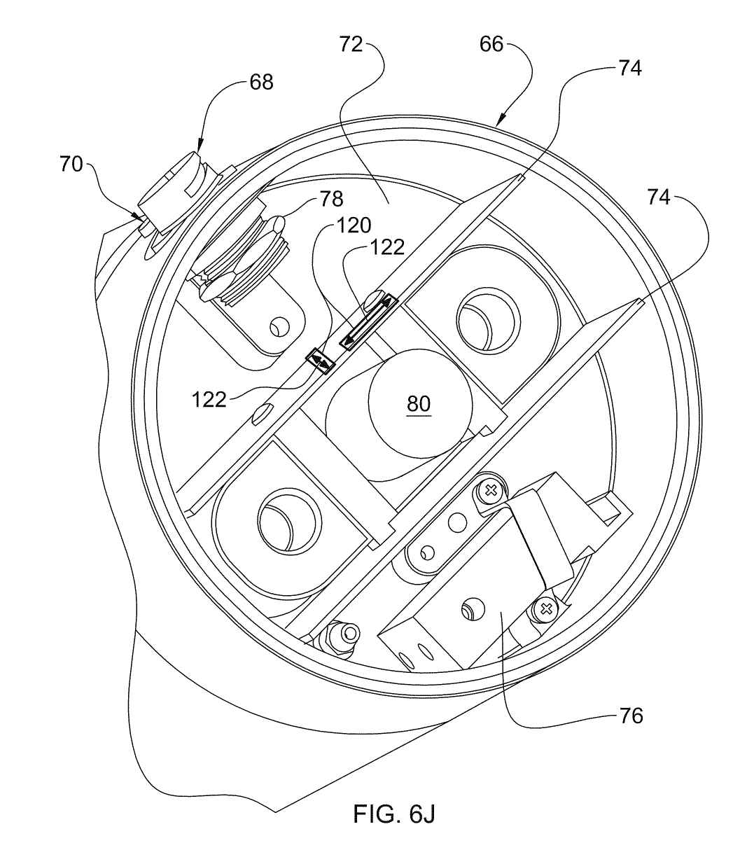

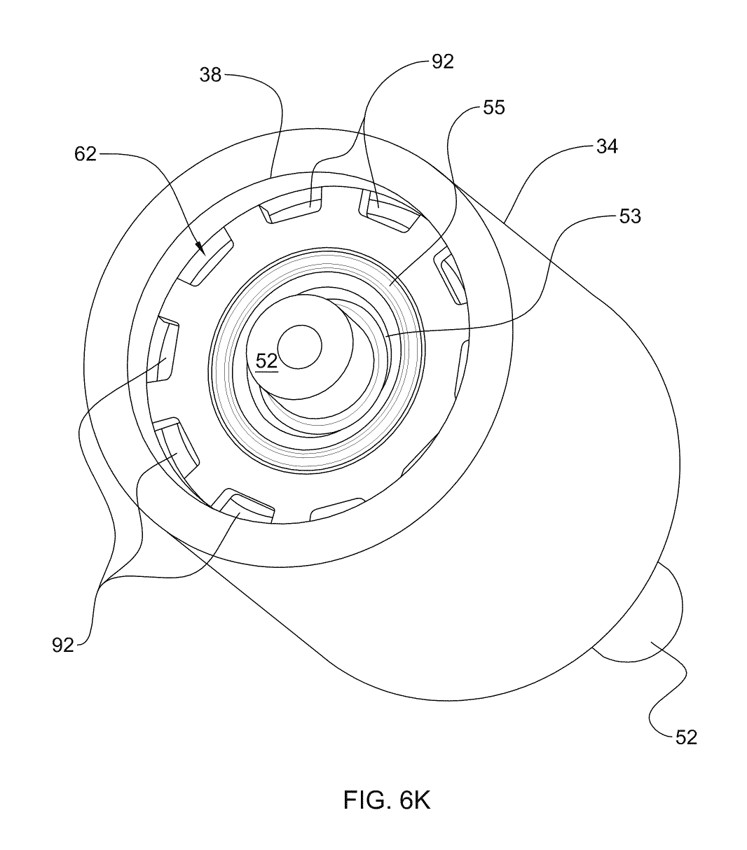

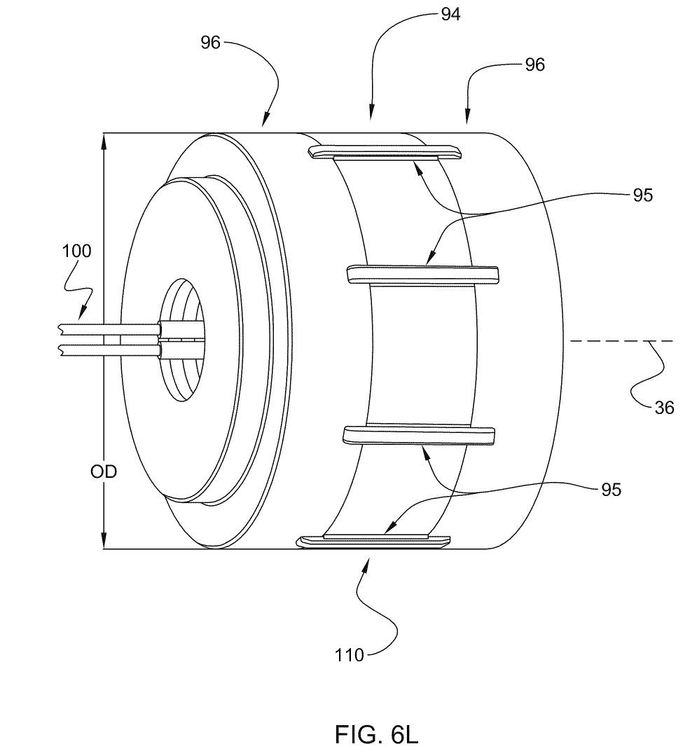

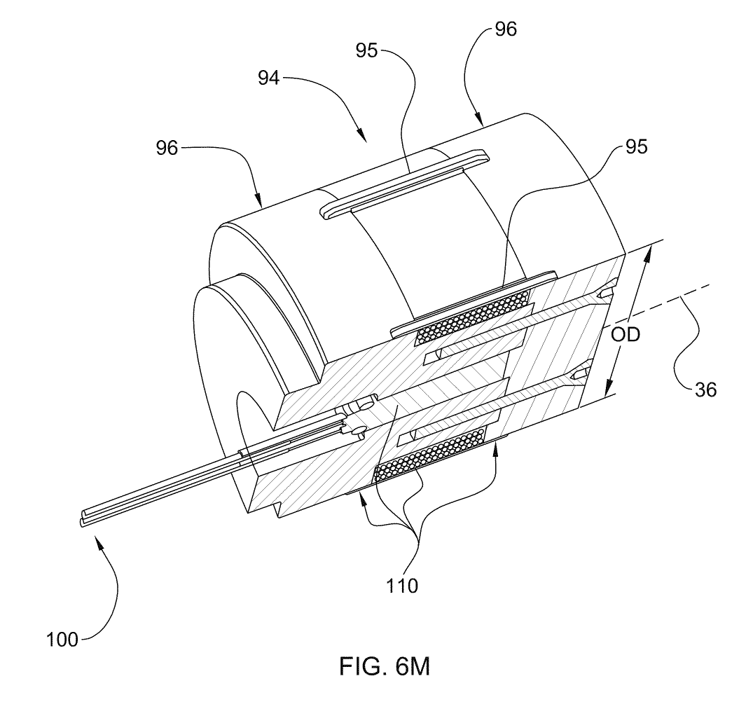

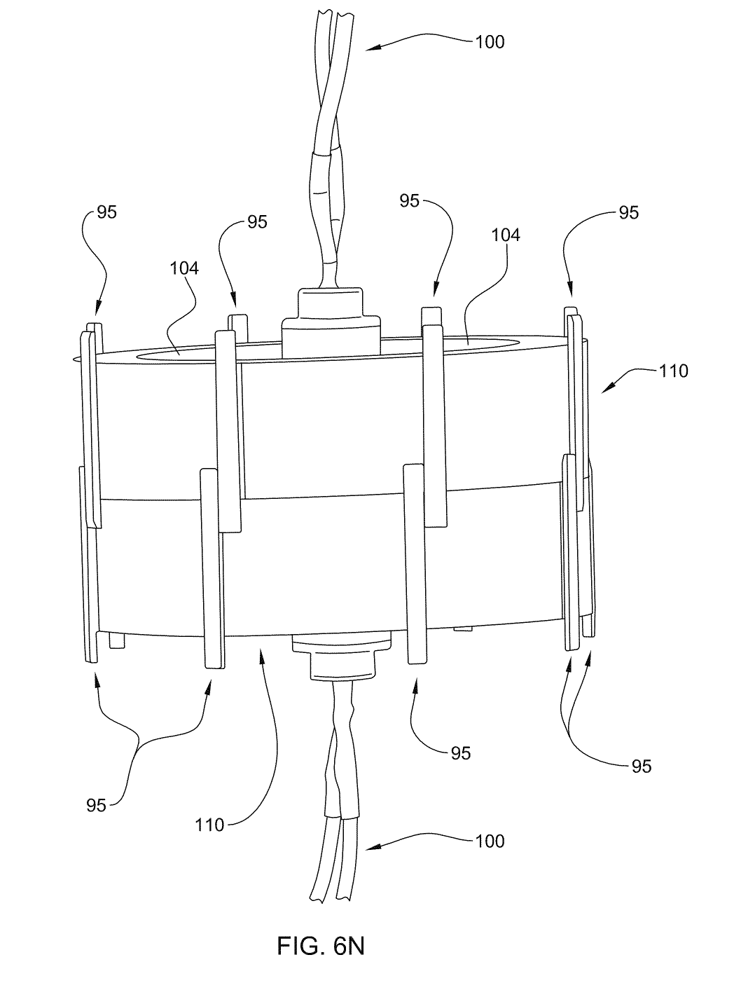

The controllable suspension system 20 includes at least one magneto-rheological fluid strut (30 in FIGS. 1-6N). Referring to FIG. 3, the controllable suspension system strut 30 includes a single-ended magneto-rheological fluid damper 32, preferably a cantilevered single-ended magneto-rheological fluid damper. As more clearly shown in FIG. 6F, the magneto-rheological fluid damper 32 includes a longitudinal damper tubular housing 34 having a longitudinally extending axis 36. The longitudinal damper tubular housing 34 has an inner wall 38 for containing a magneto-rheological fluid 40 within the tubular housing 34. Preferably the longitudinal damper tubular housing 34 is comprised of a magnetic metal material, preferably a magnetic low carbon steel as compared with a nonmagnetic metal material such as stainless steel. Preferably the magneto-rheological fluid 40 is a magneto-rheological damper fluid with the fluid containing iron particles wherein the rheology of the damper fluid changes from a free flowing liquid to a flow resistant semi-solid with controllable yield strength when exposed to a magnetic field, such as the LORD MR fluids available from LORD Corporation, Cary, N.C.

Referring to FIG. 6G, the magneto-rheological fluid damper 32 includes a cantilevered damper piston 42, the damper piston 42 including a piston head 44 movable within the damper tubular housing 34 along a longitudinal length of the tubular housing axis 36. The damper piston head 44 provides a first upper variable volume magnetorheological fluid chamber 46 and a second lower variable volume magnetorheological fluid chamber 48. The damper piston head 44 has a fluid flow gap 50 between the first upper variable volume magnetorheological fluid chamber 46 and the second lower variable volume magnetorheological fluid chamber 48 with a piston head fluid flow interface length HL, with the fluid flow gap 50 between the piston head 44 and inner wall surface 38 of the tubular housing 34 with a piston gap Pgap between the OD of the piston head 44 and the ID of the inner wall 38. The damper piston 42 includes a longitudinal cantilevered piston rod 52 for supporting the piston head 44 within the longitudinal damper tubular housing 34.

The damper piston 42 is supported within the longitudinal damper tubular housing 34 with an upper piston rod bearing assembly 54 disposed between the longitudinal damper tubular housing 34 and the longitudinal piston rod 52. The piston rod bearing assembly 54 has a piston rod bearing seal interface length BL with BL>HL and contact between the piston head 44 and the damper tubular housing inner wall 38 is inhibited. Preferably the bearing assembly 54 has a minimal bearing gap Bgap between the bearings 56 and the OD of the piston rod 52. As shown in FIG. 6G, preferably [Pgap/(HL+Stroke)] is greater than (Bgap/BL). Preferably the piston head 44 is a wear-band-free piston head, with the fluid flow gap 50 maintained between piston head sides OD and tubular housing inner wall ID with no wear band or seal on the piston between piston head 440D and inner wall 38 ID. In embodiments such as shown in FIG. 6L-6N, axially aligned coil guides 95 are preferably utilized to maintain fluid flow gap 50 and inhibit contact between the piston head 44 and the housing wall 38. Preferably the axially aligned coil guides 95 are aligned with axis 36, and preferably substantially equally spaced around the outside perimeter of EM coil 94, preferably with at least three coil guides 95, more preferably at least four guides, more preferably at least five guides, and more preferably at least six guides spaced around the OD of EM coil 94, preferably with the guides 95 occupying less than 15% of the perimeter of the EM coil, and more preferably no greater than 10% of the perimeter of the EM coil. Preferably the guides 95 are a nonmagnetic material, preferably a polymer, preferably with the guides 95 comprised of injection pressurized polymer 110 with the guides molded integral and simultaneously with their adjacent bobbin polymer overmold 110 that is pressure injected into a overmold 106, with the nonmagnetic polymer guides and overmold polymer 110 encompassing and covering the underlying wound EM coil wiring 102. Preferably the axially aligned guides 95 axially extend over the adjacent magnetic poles 96 in FIG. 6L. Referring again to FIG. 6G, the cantilevered damper piston 42 preferably minimizes the off state resistance of the damper with a minimized parasitic drag and resistance. Preferably the cantilevered damper piston 42 off state energy dissipation is minimized by substantially inhibiting contact between piston head 44 and housing wall 38 while maintaining the predetermined fluid flow gap 50 and the gap width Pgap, preferably while not utilizing a piston wear band or piston seal that encircles the piston perimeter.

Preferably the piston 42 has a constant bearing length in that the piston head 44 has no substantial bearing contact with the housing inner wall 38, with the cantilevered piston 42 providing a single ended damper 32 as compared to a double-ended damper. Preferably the rod 52 terminates with the piston head 44, with the piston head unconnected to the housing 34 except for the single bearing assembly 54. Preferably the rod 52 and the piston head 44 are unconnected to the lower housing end 58 distal from the piston rod bearing 54 and the upper housing end 60. Preferably the only mechanical connection of the piston head 44 is with the single piston rod 52 extending to the upper bearing assembly 54, with rod 52 terminating with the piston head 44, with no contact of piston head 44 with housing inner side walls 38 or the lower damper end 58 distal from the upper damper end 60 with the bearing 54. In embodiments contact of piston head 44 is inhibited with minimized perimeter occupying axially aligned guides 95. Preferably the piston head 44 is free of internal fluid flow conduits, preferably with substantially all fluid flow between the piston head 44 and housing 34 through the fluid flow gap 50, preferably with the fluid flow gap maintained with assistance of guides 95 which assist in ensuring that substantial contact between the piston head 44, particularly the magnetic poles (96 in FIGS. 6L-6N), and the housing inner side walls 38 is inhibited.

Preferably the magnetorheological fluid damper 32 includes an upper volume compensator 62. The magnetorheological fluid damper volume compensator 62 preferably is proximate the piston rod bearing assembly 54. Preferably the volume compensator 62 is adjacent the upper piston rod bearing 54. Preferably the bearing holder support structure housing 55 and the volume compensator housing are integrated together to provide an upper bearing gas charged compliance member. Preferably the gas compliance volume compensator 62 is in fluid communication with the first upper variable volume magnetorheological fluid chamber 46, with the volume compensator proximate the upper bearings 56 and the piston rod 52, preferably with upper fluid chamber 46 and volume compensator 62 in use in the suspension system 20 oriented on top relative to the force of gravity to allow gas bubble migration into volume compensator 62. Preferably the damper 32 configuration provides for a dry assembly process with the magnetorheological fluid filled into the damper after the piston 42 is assembled into the housing 34, and preferably then gas pressure charging of gas compliance volume compensator 62.

Preferably the strut 30 includes a longitudinal air gas spring 64, with the longitudinal gas spring 64 aligned with the longitudinal damper tubular housing longitudinally extending axis 36. Preferably the strut 30 includes the strut air spring 64 and the magneto-rheological fluid damper 32 aligned with the common center axis 36 and packaged together with the gas spring 64 encompassing the damper 32, with the upper end of the damper including the piston rod 52, substantially housed within the gas spring 64. Preferably the upper end of the strut 30 includes an upper strut end head member 66 (also shown in FIG. 6J) for attachment to the uppermost first body 22. Referring to FIGS. 6G and 6J, preferably the upper strut end head member 66 includes an electrical power input 68 and an air compressed gas input 70. Preferably the upper strut end head member 66 has an internal head cavity housing that includes a strut control system 72 with an electronic control circuit board 74, gas spring air sleeve leveling valve 76, and preferably also includes a high speed electrical communications connection 78, such as a CAN-Bus, for receiving outside the strut signals in addition to electrical power input 68. Preferably the upper strut end head member 66 includes a strut sensor system 80, preferably the upper sensor head end of the magneto-strictive longitudinal sensor 80 that is aligned with the piston rod 52 and axis 36 and housed within the piston rod the 52. Preferably the piston rod 52 is comprised of a nonmagnetic material, preferably a nonmagnetic metal such as stainless steel, wherein the inner housed magneto-strictive longitudinal sensor 80 provides for sensing the stroke position of the piston along the stroke length of the damper. Preferably the upper strut end member housing 66 includes the strut control system with sensors inputs, sensors, current supply, and also the pneumatic leveling valve to control leveling of the gas spring 64 in addition to controlling the magnetorheological fluid damper 32.

Referring again to FIG. 6G, preferably the upper piston rod bearing assembly 54 includes a bearing holder support structure 55 which receives a first upper bearing 56 and a distal second lower bearing 56 to provide the piston rod bearing seal interface length BL. Preferably the bearing holder support structure 55 receives a bearing seal 53 between the lower bearing 56 and the upper fluid chamber 46. Preferably the upper piston rod bearing assembly 54 includes the bearing holder support structure 55 which receives the at least first bearing 56 and includes compliance member cavity 82 for receiving a volume compensator gas compliance member 84, preferably with the gas compliance member flexible fluid gas partition diaphragm 84 flexibly fixed to the support structure 55 allowing expansion and contraction of the gas filled diaphragm cavity to compensate for magnetorheological fluid volume changes, preferably with the gas compliance member flexible elastomer fluid gas partition diaphragm 84 radially expandable between the support structure 55 and the housing 34. Preferably the upper piston rod bearing assembly 54 includes the bearing holder support structure 55 which receives the at least first bearing 56 and includes a sensor target magnet holder 86 which receives a target magnet 88 for the magnetostrictive sensor 80 in the non-magnetic piston rod 52. Preferably the upper volume compensator 62 is vertically oriented relative to gravity in operation of the suspension system with the volume compensator proximate the piston rod bearing.

Preferably volume compensator 62 is adjacent the upper piston rod bearing assembly 54, preferably with the bearing holder support structure 55 and volume compensator housing cavity 82 integrated to provide an upper damper rod bearing gas charged compliance member. Preferably the rod bearing gas charged compliance member support structure 55 includes a gas compliance charging conduit 90 for filling the cavity 82 with a pressurized gas, preferably after the piston has been assembled into the housing and bearing and the damper has been filled with the magnetorheological fluid. Preferably the volume compensator 62 is in fluid communication with the adjacent damper fluid chamber 46 through a plurality of fluid volume compensating conduits (92 in FIG. 6K) between the housing 34 and the piston rod 52, which allow flow of fluid into and out of the volume compensator, preferably with the conduits 92 providing for greater flow than the piston head gap 50, preferably a relatively high flow into and out compared to piston head flow, with relatively low resistance to flow into the volume compensator such that it is not dynamically isolated from the rest of the working magnetorheological fluid.

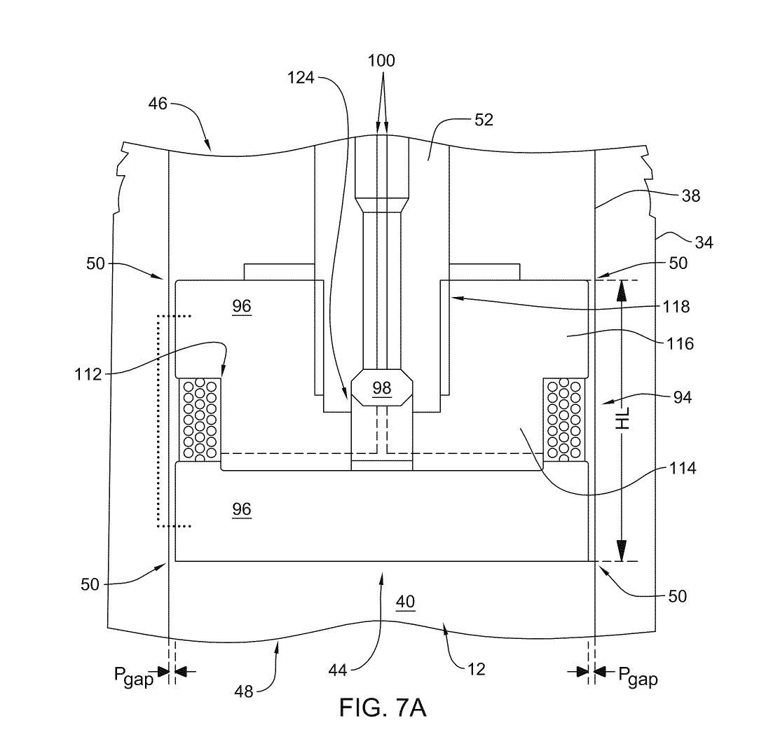

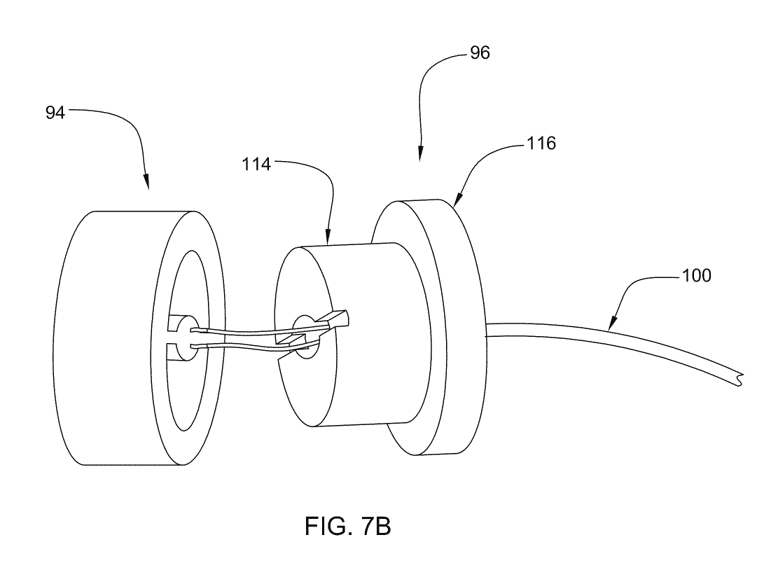

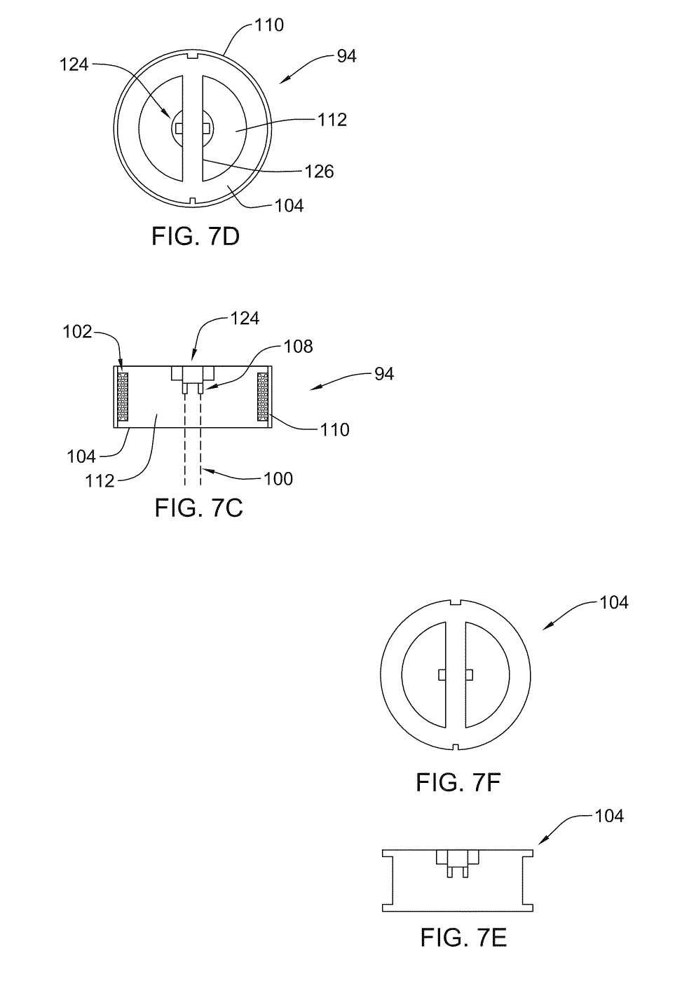

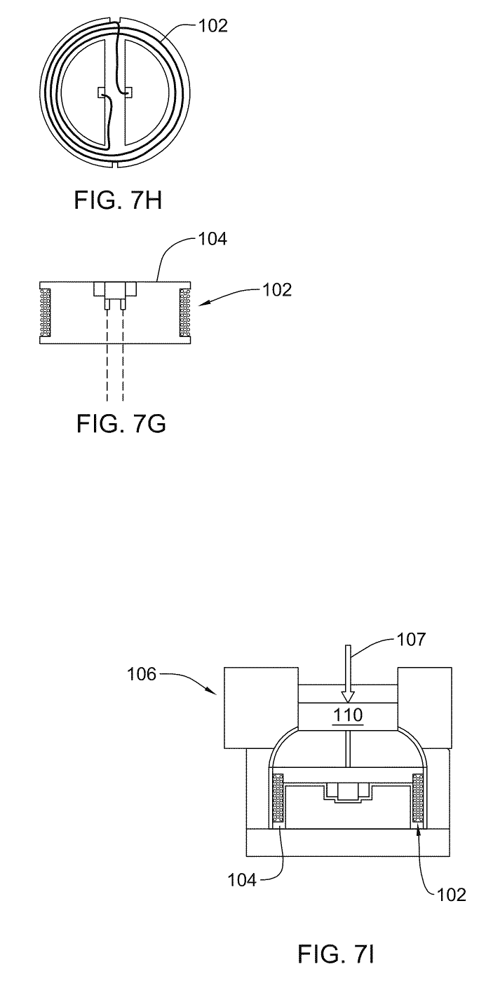

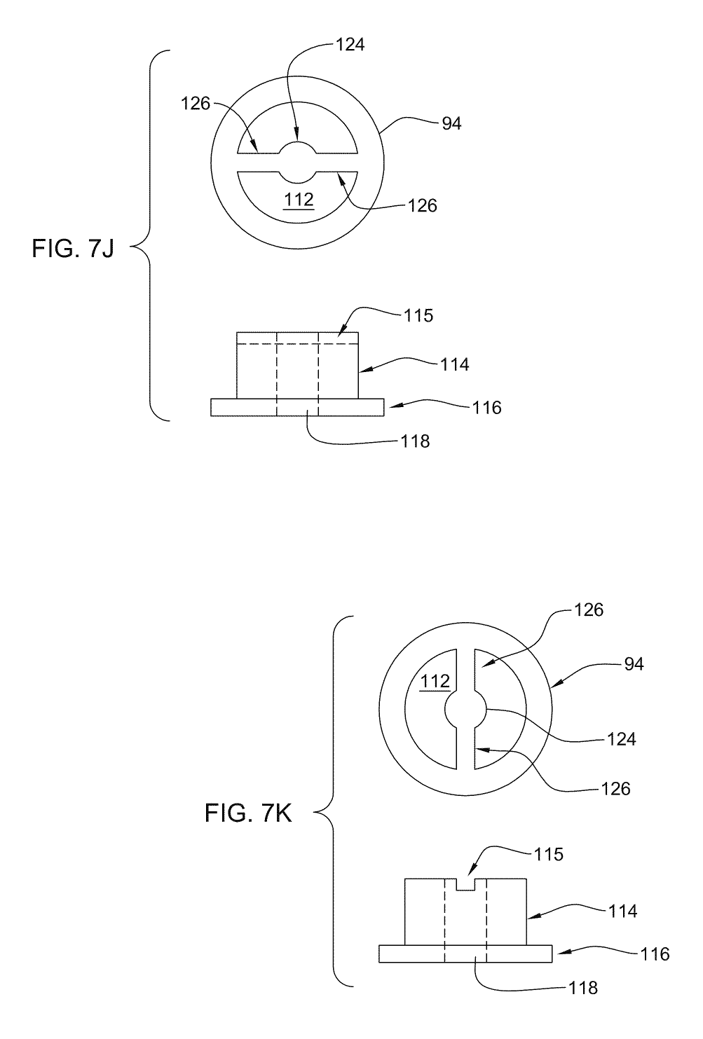

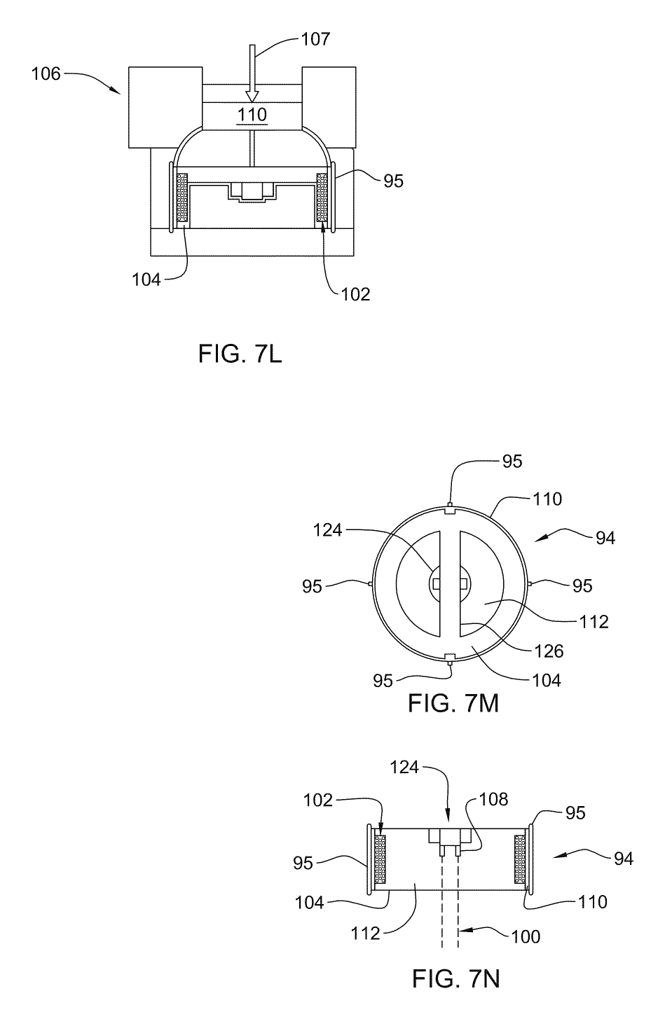

Referring to FIGS. 7A-7N, the piston head 44 includes the electromagnetic coil 94 and an upper and lower magnetic pole 96 for controlling the flow of magneto-rheological fluid 40 between the upper and lower chambers 46 and 48, preferably with the electromagnetic coil 94 comprised of an electrically insulated encapsulant injected pressurized polymer overmolded electromagnetic magnetorheological fluid coil 94. The preferred modular component injected pressurized polymer overmolded electromagnetic magneto-rheological fluid coil 94 is shown in FIG. 7B. Preferably the EM coil insulated wire (102 in FIGS. 7C, 7H-7N) is wound on a non-magnetic plastic bobbin (104 in FIGS. 7C, 7G-7I), with the coiled wire 102 on the bobbin 104 pressure overmolded with an injected pressurized non-magnetic polymer (110 in FIGS. 7C, 7D, 7I) in a pressurized injection overmold 106 under an applied pressure 107. Preferably the pressurized injection overmolded EM coil 94 includes a first and second wire pins 108 for connection with a current supply wire circuit 100. Preferably the modular component pressurized injection overmolded EM coil 94 is sandwiched between upper and lower magnetic metal poles 96, to provide the current controllable EM coil piston head 44, with the modular component pressurized injection overmolded EM coil 94 overmolded EM coil and poles 96 sized to provide the predetermined gap 50 with the housing inner wall 38, with the pressurized injection overmolded EM coil magnetic field controlling magnetorheological fluid flow proximate the piston head EM coil, with preferred embodiments molded with axially aligned guides 95 as shown in FIG. 7L-7N. FIG. 6N show two overmolded EM coils with molded guides 95 placed head to head to illustrate how the guides 95 extend beyond the coil top and bottom sides such that they will overlap the adjacent magnetic poles when assembled into the piston head, with the guides equally spaced around the EM coil outer perimeter in a piston axially centering pattern centered and aligned with the longitudinal extending axis 36 of damper 32.

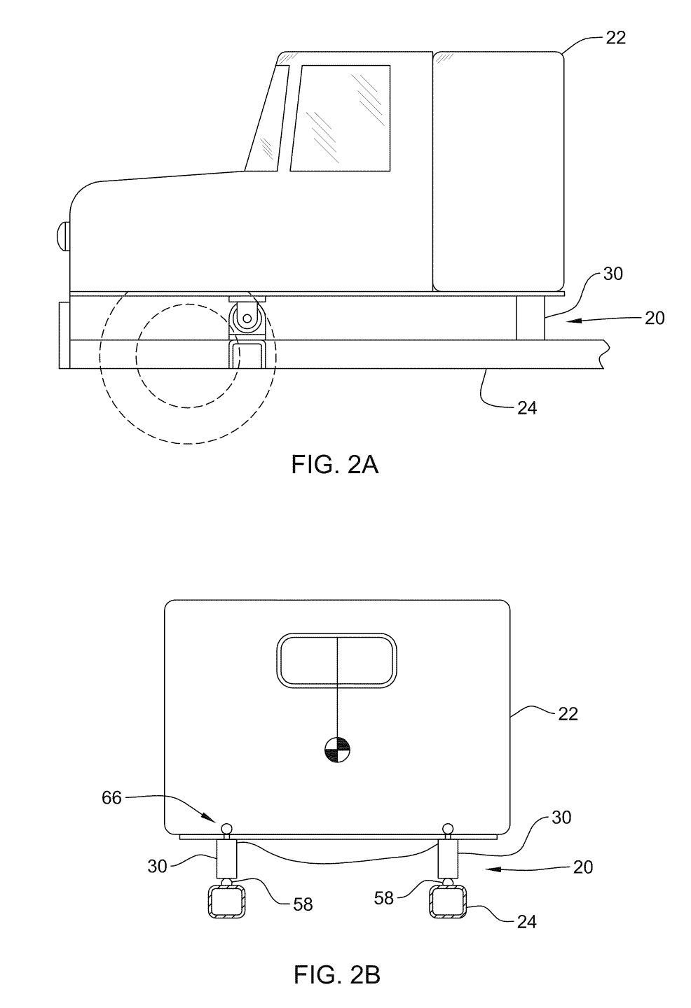

Referring again to FIG. 3, preferably the controllable suspension system 20 includes a first strut 30 and at least a second cantilevered magnetorheological fluid damper strut 32 between the first body (22 in FIGS. 1, 2A, 2B) and the second body (24 in FIGS. 1, 2A, 2B), preferably with both struts 30 having outer encompassing air spring sleeves 64. Preferably the controllable suspension system 20 includes a third cantilevered magnetorheological fluid damper strut 30 between the first body and the second body. In one embodiment, at least two of the more than one struts 30 operate independently with their own self contained sensor and control systems in their strut head member housing 66, preferably with no master control signals communicating between the at least two struts from a suspension system master controller. In one embodiment, the struts 30 are self-contained, self-controlled struts that house their own control systems, preferably with only electrical power and compressed gas supplied from a master suspension system source, such as a vehicle battery electrical power system and a compressed air system. In a preferred embodiment with the more than one strut 30 operating, preferably such as with four struts, a first master controlling strut 30″ controls a second controlled dependent strut 30′ with master control signals communicating between the at least two struts 30″ and 30′, such as with the master strut 30″ that sends controls to the other dependent strut 30″ in addition to its own control.

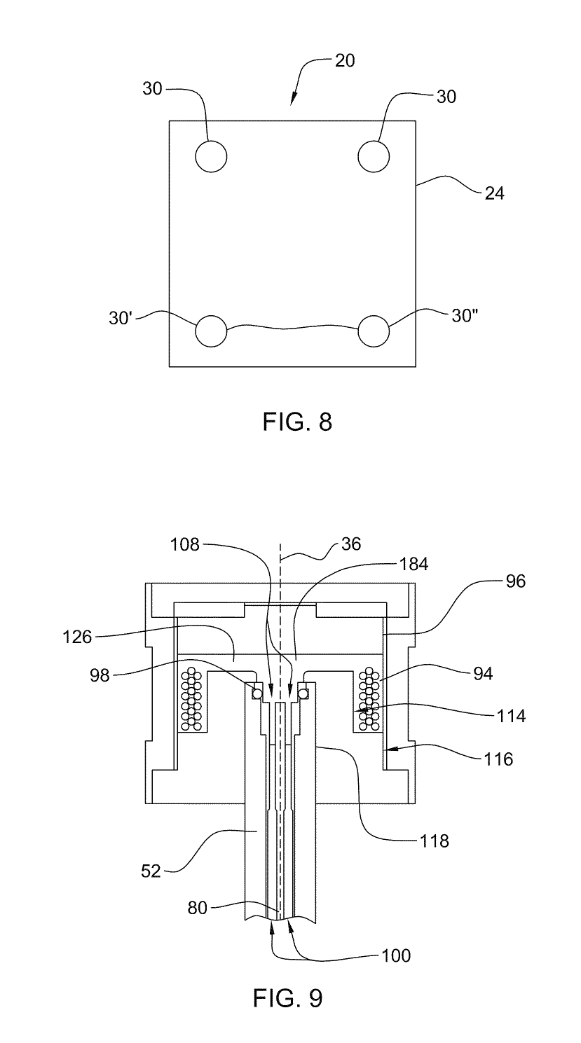

In a preferred embodiment the suspension system 20 is a cab suspension system with two back cab struts 30 and the front of the vehicle cab is mounted without such controllable cantilevered magnetorheological fluid damper struts 30, such as hard mount or mounted with noncontrolled elastomer mounts. In a preferred cab suspension system 20 embodiment with two rear back cab struts 30 and the front of the vehicle cab is mounted without such controllable cantilevered magnetorheological fluid damper struts 30, the struts 30 are self controlled and autonomous with each having its own circuit board control system, with the strut control system sharing and communicating its sensor data, such as its processed accelerometer information, with each other through the electrical communication connection 78 link to control roll of the cab body. In preferred embodiments the controllable magnetorheological fluid damper struts 30 are self controlled and autonomous with each having its own circuit board control system 72 housed in its upper strut end head member 66, with the struts control system sharing its sensor data through its electrical communication connection 78 to control a motion of the cab relative to the frame, such as to control roll, or with a four point strut suspension controlling roll and pitch of the cab with the four self controlled sensor data sharing struts 30. In a preferred embodiment, as illustrated in FIG. 8, at least three struts 30 provide for a three point cab suspension system for control of roll and pitch, preferably with three independent self-controlled struts 30, 30, and 30′ and one dependent strut 30″.

In an embodiment the invention includes a controllable damper for controlling motion. The controllable damper 32 provides for the controlling or relative motion between a first body 22 and a second body 24, preferably with the damper controlling motion in a vehicle, most preferably in a suspension system 20 between a vehicle frame and the vehicles cab. In alternative embodiments the damper 32 provides for controlling motion in non-vehicle stationary suspensions. The controllable damper 32 includes a longitudinal damper tubular housing 34 having a longitudinally extending axis 36. The longitudinal damper tubular housing 34 has an inner wall 38 for containing a magnetorheological fluid 40 within the tubular housing, with the damper housing having an upper damper end 60 and a lower damper end 58. The controllable damper 32 includes a cantilevered single ended damper piston 42. The damper piston 42 includes a piston head 44 movable within the damper tubular housing 34 along a longitudinal stroke length of the tubular housing, with the damper piston head 44 providing a first upper variable volume magnetorheological fluid chamber 46 and a second lower variable volume magnetorheological fluid chamber 48. The damper piston head 44 has a fluid flow gap 50 between the first upper variable volume magnetorheological fluid chamber 46 and the second lower variable volume magnetorheological fluid chamber 48 with a piston head fluid flow interface length HL, preferably with the gap 50 having a width Pgap between the piston head OD and inner surface ID of the tubular housing 34. The damper piston 42 has a longitudinal piston rod 52 for supporting the piston head 44 within the longitudinal damper tubular housing 34. Preferably the cantilevered piston rod 52 is the only mechanical support for supporting the piston head within the damper housing with a bearing. The piston 42 is supported within the longitudinal damper tubular housing with an upper piston rod bearing assembly 54 disposed between the longitudinal damper tubular housing 34 and the longitudinal piston rod 52. The piston rod bearing assembly 54 having a piston rod bearing seal interface length BL, wherein contact between the piston head 44 and the damper tubular housing inner wall 38 is inhibited. Preferably the piston head 44 is a wearbandfree piston head, with the magnetorheological fluid flow gap width Pgap maintained between piston head OD sides and tubular housing inner wall with no wear band or seal on the piston head or between the piston OD sides and the inner wall. Preferably the damper 32 minimizes off state resistance a minimized parasitic drag and resistance. Preferably the off state energy dissipation of damper 32 when no controlling current is supplied to the piston head EM coil 94 is minimized by inhibiting contact between the piston head and housing wall while maintaining the predetermined magnetorheological fluid flow gap cylindrical shell of length HL and thickness Pgap. Preferably the piston 42 has a constant bearing length BL in that the piston head 44 has no bearing contact with the housing inner wall 38. Preferably the damper 32 is a single ended damper as compared to a double ended damper, preferably with the rod 52 terminating with the piston head 44, with the piston head otherwise unconnected to the housing and the lower housing end 58 distal from the piston rod bearing 54, preferably with the only mechanical connection of the piston head 44 with the single piston rod extending to the upper bearing assembly, with the rod terminating in the piston head. Preferably the piston head 44 is free of internal fluid flow conduits inside the piston head OD, preferably with substantially all fluid flow of the magnetorheological fluid 40 between the piston head and the housing through the magnetorheological fluid flow gap 50. Preferably the controllable damper 32 cantilevered piston length BL is greater than the piston head cylindrical shell gap length HL.

Preferably the controllable magnetorheological fluid damper 32 includes an upper damper volume compensator 62. The volume compensator 62 is proximate the piston rod bearing assembly 54. Preferably the gas compliance volume compensator 62 is adjacent the upper piston rod bearing 54, preferably with the bearing holder support structure 55 and the volume compensator housing cavity 82 integrated into an upper bearing gas charged compliance member. Preferably the gas compliance volume compensator 62 is in fluid communication with the first upper variable volume magnetorheological fluid chamber 46, with the volume compensator proximate the upper bearing and the piston rod, preferably with upper fluid chamber 46 and volume compensator 62 in use oriented on top of lower fluid chamber 48 relative to the force of gravity to allow gas bubble migration upward into volume compensator 62. Preferably the damper 32 provides for a dry assembly process with magnetorheological fluid filled after the piston 42 is assembled in the housing 34, preferably through a lower housing end opening 59, then gas pressure charging of the gas compliance volume compensator 62 through an upper end conduit 90. Preferably the piston rod bearing assembly bearing holder support structure 55 includes fluid flow conduits 92 to allow flow of fluid into and out of the volume compensator, preferably with conduits 92 providing for greater flow than the magnetorheological piston head gap 50, preferably with relatively high flow into and out of the volume compensator as compared to piston head flow, with relatively low resistance to flow into volume compensator.

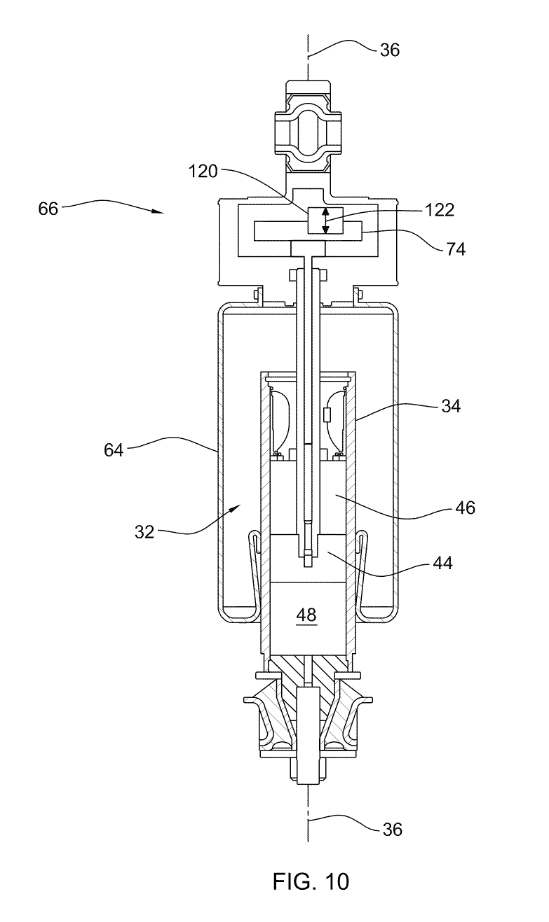

Preferably the controllable magnetorheological fluid damper 32 includes an upper strut end head member 66 with an electrical power input 68. Preferably the upper strut end head member houses the damper control system 72 with electronic control circuit board 74. In a preferred embodiment the power input is included with a multiple wire array connector 78, such as a CAN bus electrical connector 78, preferably with the multiple wire electrical connection providing for receiving outside the strut damper control signals in addition to electrical power input that generates the magnetorheological fluid controllable magnetic field. Preferably the upper strut end head member houses the damper control sensor system, preferably including the upper head end of the magnetostrictive longitudinal sensor 80 that is aligned axis 36 and housed within the piston rod 52. Preferably the upper strut end head member housing includes the control system for also controlling leveling with the gas spring with a leveling valve 76 for controlling pneumatic leveling of the strut 30. Preferably the strut and damper with the upper strut end head member 66 is an intelligent self-contained damper system with the head member containing the electronics control system circuit boards 74 that receives sensor inputs such as from the magnetostrictive sensor 80 and accelerometers 120, and controls the electrical current supplied to the piston head EM coil 94 through the current supply wire circuit 100 to control the damper 32, preferably with the control electronics including accelerometer sensors 120, preferably an at least one accelerometer axis acceleration sensed, preferably with a first accelerometer axis 122 aligned with the damper axis 36 (shown in FIG. 10). Preferably the accelerometer sensor 120 is an at least two axis accelerometer, and most preferably a three axis accelerometer, with the first axis 122 aligned with the damper axis 36, the second and third axis normal to the damper axis 36.

Preferably the controllable magnetorheological fluid damper upper piston rod bearing assembly 54 includes a bearing holder support structure 55 which receives a first upper bearing 56, a distal second lower bearing 56, and a piston rod seal 53 to provide the piston rod bearing seal interface length BL. Preferably the controllable magnetorheological fluid damper upper piston rod bearing assembly 54 includes bearing holder 55 which receives at least first bearing 56 and a compliance member cavity 82 for receiving a volume compensator gas compliance member 84. Preferably the controllable magnetorheologicai fluid damper upper piston rod bearing assembly 54 includes bearing holder 55 which receives at least first bearing 56 and a sensor target magnet holder 86 which receives a target magnet 88 for producing a sensor signal in the proximate magnetostrictive sensor 80 in the non-magnetic piston rod 52, to provide a sensed measurement of the location of the target magnet along the length of sensor 80 to provide a measurement of the stroke position of the piston head in the damper housing that is used as an input into the damper electronic control system.

Preferably the controllable magnetorheological fluid damper piston head 42 includes an insulating encapsulant injected pressurized polymer overmolded electromagnetic coil 94, with the piston head, overmolded electromagnetic coil and magnetic poles ODs sized to provide the predetermined gap Pgap with the housing inner wall ID, with the gap 50 maintained to inhibit contact with the wall 38 and to provide the fluid flow gap with the coil 94 producing a magnetic field for controlling magnetorheological fluid flow through the gap. The controllable piston head electromagnetic coil 94, upper and lower magnetic poles 96 with a variable applied current producing a controlling magnetic field for controlling the flow of magnetorheological fluid 40 between the upper and lower chambers 46 and 48, with the electromagnetic coil 94 comprised of an electrically insulated injected pressurized polymer overmolded electromagnetic magnetorheological fluid coil 94. The preferred modular component injected pressurized polymer overmolded electromagnetic magnetorheological fluid coil 94 is shown in FIG. 7A-7I. Preferably the EM coil insulated wire 102 is wound on the non-magnetic plastic bobbin 104, with the coiled wire 102 on the bobbin 104 pressure overmolded with the injected pressurized polymer 110 in the pressurized injection overmold 106 under an applied pressure 107. Preferably the pressurized injection overmolded EM coil 94 includes first and second wire pins 108 for connection with a current supply wire circuit 100 that supplies the controlling current output by the control system. Preferably the modular component pressurized injection overmolded EM coil 94 is sandwiched between the upper and lower magnetic metal poles 96, to provide the current controllable EM coil piston head 44, with the modular component pressurized injection overmolded EM coil 94 overmolded EM coil and poles 96 sized to provide the predetermined gap 50 with the housing inner wall 38, with the pressurized injection overmolded EM coil magnetic field controlling magnetorheological fluid flow proximate the piston head EM coil.

In an embodiment the invention includes a method of making a controllable suspension system for controlling the relative motion between a first body and a second body. Preferably the invention provides a method of making a controllable vehicle suspension system for controlling the relative motion between a first vehicle body and a second vehicle body, most preferably a method of making a vehicle cab suspensions for controlling the motion between a first body cab 22 and a second body frame 24. The method includes providing the longitudinal damper tubular housing having a longitudinally extending axis, the longitudinal damper tubular housing 34 having inner wall 38 for containing a magnetorheological fluid within the tubular housing. The provided longitudinal damper tubular housing 34 has a first upper end 60 and a second distal lower end 58, with the housing centered about axis 36. The method includes providing piston rod bearing assembly 54 having piston rod bearing seal interface length BL for supporting damper piston 42 within the longitudinal damper tubular housing 34. The method includes providing cantilevered damper piston 42 including piston head 44 and longitudinal piston rod 52. Cantilever piston rod 52 supports the piston head 44 within the longitudinal damper tubular housing, with the upper piston rod bearing assembly 54 disposed between the longitudinal damper tubular housing and the longitudinal piston rod. The method includes disposing the piston rod bearing assembly 54 in the longitudinal damper tubular housing 34 proximate the first upper end 60. The method includes receiving the damper piston longitudinal piston rod 53 in the piston rod bearing assembly 54, wherein the piston head 44 is movable within the damper tubular housing along the longitudinal length of the tubular housing, with the damper piston head providing a first upper variable volume magnetorheological fluid chamber 46 and a second lower variable volume magnetorheological fluid chamber 48, the damper piston head having a fluid flow gap 50 between the first upper variable volume magnetorheological fluid chamber and the second lower variable volume magnetorheological fluid chamber with a piston head fluid flow interface length HL with contact between the piston head and the damper tubular housing inner wall inhibited. The method includes providing magnetorheological damper fluid 40 and disposing the magnetorheological damper fluid 40 in the damper tubular housing 34. The damper provides for controlling the relative motion between the first body 22 and the second body 24. Preferably the method includes providing the longitudinal air strut gas spring 64, and aligning the longitudinal strut gas spring with the longitudinal damper tubular housing longitudinally extending axis 36 with the strut air spring and magnetorheological damper aligned and packaged together with the gas spring encompassing the magnetorheological damper, preferably with the upper end 60 and the piston rod 52 substantially housed within the gas spring 64, preferably with the upper end of strut including the upper strut end head member 66 for attachment to the uppermost first or second body. Preferably the upper strut end head member 66 includes the electrical power input and the compressed air gas input, along with the strut control system with electronic control circuit boards 74, gas spring air sleeve leveling valve 76. In preferred embodiments the upper strut end head member 66 includes the CAN-Bus electrical connection for receiving outside the strut control signals in addition to electrical power input into the strut. In preferred embodiments the upper strut end head member 66 includes the damper sensor system with the end of magneto-strictive longitudinal sensor 80 that is aligned and housed within the piston rod. Preferably the piston rod bearing assembly 54 is provided with the piston rod bearing seal interface length BL greater than the HL. Preferably the upper volume compensator 62 is provided and disposed proximate the piston rod bearing assembly 54. Preferably the upper piston rod bearing assembly includes the bearing holder which receives the first upper bearing and the distal second lower bearing to provide the piston rod bearing seal interface length BL. Preferably the upper piston rod bearing assembly includes the bearing holder which receives the at least first bearing and includes the compliance member cavity for receiving the volume compensator gas compliance member. Preferably the upper piston rod bearing assembly includes the bearing holder which receives the at least first bearing and has the sensor target magnet holder which receives the target magnet for the magnetostrictive sensor in the non-magnetic piston rod. Preferably the magnetorheological fluid damper includes the upper volume compensator, with the volume compensator proximate the piston rod bearing. Preferably at least a first cantilevered magnetorheological fluid damper, and at least a second cantilevered magnetorheological fluid damper are disposed between the first body and the second body. Preferably the at least a third cantilevered magnetorheological fluid damper is disposed between the first body and the second body.

Preferably the invention includes the method of making the controllable damper for controlling motion. Preferably the method includes providing the longitudinal damper tubular housing having the longitudinally extending axis, the longitudinal damper tubular housing having the inner wall for containing the magnetorheological fluid within the tubular housing, the longitudinal damper tubular housing having the first upper end and the second distal lower end. The method includes providing the piston rod bearing assembly, the piston rod bearing assembly having the piston rod bearing seal interface length BL for supporting the damper piston within the longitudinal damper tubular housing. The method includes providing the cantilevered damper piston, the damper piston including the piston head and the longitudinal piston rod for supporting the piston head within the longitudinal damper tubular housing. The method includes disposing the piston rod bearing assembly in the longitudinal damper tubular housing proximate the first upper end. The method includes receiving the damper piston longitudinal piston rod in the piston rod bearing assembly, wherein the piston head is movable within the damper tubular housing along the longitudinal length of the tubular housing, with the damper piston head providing the first upper variable volume magnetorheological fluid chamber and the second lower variable volume magnetorheological fluid chamber, the damper piston head having the fluid flow gap between the first upper variable volume magnetorheological fluid chamber and the second lower variable volume magnetorheological fluid chamber with the piston head fluid flow interface length HL, with HL<BL and contact between the piston head and the damper tubular housing inner wall inhibited. Preferably the method includes providing the upper volume compensator, and disposing the volume compensator proximate the piston rod bearing assembly. Preferably the method includes providing the upper strut end head member with the electrical power input and disposing the strut end head member proximate the damper tubular housing first end. Preferably the method includes providing the upper piston rod bearing assembly with the bearing holder support structure which receives the first upper bearing and the distal second lower bearing to provide the piston rod bearing seal interface length BL. Preferably the method includes providing the upper piston rod bearing assembly with the bearing holder support structure which receives at least the first bearing and includes the compliance member cavity for receiving the volume compensator gas compliance member. Preferably the method includes providing the upper piston rod bearing assembly with the bearing holder support structure which receives at least the first bearing and includes the sensor target magnet holder which receives the target magnet. Preferably the method includes providing the piston head with the injected pressurized polymer overmolded electromagnetic coil.

In an embodiment the invention includes a method of making a controllable damper for controlling motion. The method includes providing a longitudinal damper tubular housing 34 having a longitudinally extending axis 36. The provided longitudinal damper tubular housing 34 has an inner wall 38 for containing a magnetorheological fluid 40 within the tubular housing. The longitudinal damper tubular housing 34 has a first upper end 60 and a second distal lower end 58. The method includes providing a piston rod bearing assembly 54, the piston rod bearing assembly having a piston rod bearing seal interface length BL for supporting a damper piston 42 within the longitudinal damper tubular housing 34. The method includes providing a damper piston 42, the damper piston including a magnetorheological fluid piston head 44 and a longitudinal piston rod 52 for supporting the piston head within the longitudinal damper tubular housing 34. The magnetorheological fluid piston head 44 includes an insulating injected pressurized polymer overmolded electromagnetic magnetorheological fluid coil 94. The controllable magnetorheological fluid damper piston insulating encapsulant injected pressurized polymer overmolded electromagnetic coil 94 and magnetic poles 96 preferably having ODs sized to provide the predetermined gap 50 Pgap with the housing inner wall ID, with the gap 50 maintained to inhibit contact with the wall 38 and to provide the fluid flow gap 50 with the coil 94 producing a magnetic field for controlling magnetorheological fluid flow through the gap. The controllable piston head electromagnetic coil 94, upper and lower magnetic poles 96 with a variable applied current producing a controlling magnetic field for controlling the flow of magnetorheological fluid 40 between the upper and lower chambers 46 and 48, with the electromagnetic coil 94 comprised of the modular component electrically insulated injected pressurized polymer overmolded electromagnetic magnetorheological fluid coil 94. The preferred modular component injected pressurized polymer overmolded electromagnetic magnetorheological fluid coil 94 is shown in FIG. 7A-7I. Preferably the EM coil insulated wire 102 is wound on the non-magnetic plastic polymer bobbin 104, with the coiled wire 102 on the bobbin 104 pressure overmolded with the injected pressurized polymer 110 in the pressurized injection overmold 106 under an applied pressure 107. Preferably the non-magnetic plastic polymer bobbin 104 and the injected pressurized polymer 110 are comprised of substantially the same base polymer, in a preferred embodiment the bobbin 104 and the pressurized injection overmold polymer 110 are comprised of nylon. In a preferred embodiment the bobbin 104 is comprised of a glass filled nylon and the pressurized injection overmold polymer 110 is comprised of a nylon, preferably a non-glass-filled nylon. In a preferred embodiment the bobbin 104 and the overmold polymer 110 are comprised of a common polymer, preferably with the common polymer comprised of a nylon. Preferably the pressurized injection overmolded EM coil 94 includes first and second wire pins 108 for connection with a current supply wire circuit 100 that supplies the controlling current outputted by the damper control system. Preferably the modular component pressurized injection overmolded EM coil 94 is sandwiched between the upper and lower magnetic metal poles 96, to provide the current controllable EM coil piston head 44. The modular component pressurized injection overmolded EM coil 94 overmolded EM coil and poles 96 provide a magnetic field for controlling magnetorheological fluid flow proximate the piston head EM coil. The method includes disposing the piston rod bearing assembly 54 in the longitudinal damper tubular housing 34 proximate the first upper end 60. The method includes receiving the damper piston longitudinal piston rod 52 in the piston rod bearing assembly 54, wherein the magnetorheological fluid piston head 44 is movable within the damper tubular housing along the longitudinal stroke length of the tubular housing and the axis 36, with the damper piston head 44 providing first upper variable volume magnetorheological fluid chamber 46, second lower variable volume magnetorheological fluid chamber 48, and the fluid flow gap between the first upper variable volume magnetorheological fluid chamber and the second lower variable volume magnetorheological fluid chamber. The method includes providing a magnetorheological damper fluid 40 and disposing the magnetorheological damper fluid 40 in the damper tubular housing 34 wherein a current supplied to the injected pressurized polymer overmolded electromagnetic magnetorheological fluid coil 94 controls the flow of the magnetorheological damper fluid 40 proximate the injected pressurized polymer overmolded electromagnetic magnetorheological fluid coil 94. The method includes injection molding a polymer 110 with a positive pressure into a overmold 106 containing the wire wrapped electromagnetic coil nonmagnetic plastic bobbin 104 to provide the plastic modular injected pressurized polymer overmolded electromagnetic magnetorheological fluid coil 94 for assembly into the piston head 44. Preferably the EM coil insulated wire 102 is wound on a non-magnetic plastic bobbin 104 with the coiled wire and bobbin pressure overmolded with an injected pressurized polymer 110 in a predetermined sized cavity overmold 106 under pressure. Preferably the overmolded EM coil 94 includes first and second wire pins 108 for connection with a current supply circuit 100. Preferably the modular component EM coil 94 is sized and shaped to be sandwiched between upper and lower magnetic metal poles 96. Preferably the wire 102 is wound on non-magnetic plastic bobbin 104, and then placed in coil overmold 106, with insulating injected pressurized polymer nylon polymer 110 overmolded around the bobbin and wire. Preferably the piston head 44 and its overmolded EM coil 94 and poles 96 are sized to provide predetermined gap 50 with the housing inner wall 38, with the EM coil magnetic field controlling fluid flow 40 proximate the piston head EM coil 94. Preferably the damper overmolded EM coil 94 in damper 32 provides for controlling the relative motion between first body 22 and the second body 24, preferably with the damper 32 providing a controllable strut 30. Preferably the damper overmolded EM coil 94 is utilized in the making of single ended dampers 32 as compared to double ended dampers, preferably with the rod 52 terminating with the piston head 44 that contains the coil 94. Preferably the piston head 44 is free of internal fluid flow conduits, preferably substantially all fluid flow is between piston head and housing through the magnetorheological fluid flow gap proximate the EM coil OD, preferably with the piston 42 having a constant bearing length with the piston head 44 having no bearing contact with the housing inner wall 38. In alternative preferred embodiments the piston head 44 has a wear band and contact with the housing wall 38. Preferably the method includes providing upper volume compensator 62, and disposing the volume compensator 62 proximate the piston rod bearing assembly 54. Preferably the volume compensator 62 is adjacent the upper piston rod bearing 54, preferably with the bearing holder support structure and volume compensator housing integrated into an upper bearing gas charged compliance member. Preferably the gas compliance volume compensator 62 is in fluid communication with the first upper variable volume magnetorheological fluid chamber 46, with the volume compensator proximate the upper bearing 56 and the piston rod 52, preferably with the upper fluid chamber 46 and volume compensator 62 in use oriented on the top end of the damper relative to the force of gravity. Preferably the damper components provide for dry assembly of the damper piston in the housing with magnetorheological fluid 40 disposed into the damper after the piston is assembled into the housing, and then gas pressure charging of gas compliance volume compensator 62. Preferably the piston rod bearing assembly bearing holder support structure 55 includes fluid flow conduits 92 to allow flow of fluid 40 into and out of the volume compensator 62, preferably with the conduits providing for greater flow than the magnetorheological piston head gap 50. Preferably the method includes providing upper strut end head member 66 with an electrical power input 68 and disposing the strut end head member 66 proximate the damper tubular housing first end 60, with the head member providing the controlling current to the EM coil 94 through circuit 100. Preferably the strut end head member 66 includes the control system 72 with electronic control circuit boards 74, preferably also including CAN-Bus electrical connection 78 for receiving outside the strut control signals in addition to electrical power input 68. Preferably the head member 66 includes a damper sensor system, preferably with the end of the magneto-strictive longitudinal sensor 80 that is aligned and housed within the piston rod 52. Preferably the upper strut end head member housing 66 includes the control system of the magnetorheological damper 32 and the gas spring 64 for controlling pneumatic leveling of the strut. Preferably the damper is an intelligent self-contained damper system with the head member 66 containing the electronics control system that receives sensor inputs and control the electrical current supplied to the EM coil in the piston head to control the damper, preferably with control electronics including accelerometer sensors 120, preferably with a 2-axis alignment oriented with the axis 36. Preferably the upper strut end head member housing cavity 66 houses the electronic control sensor system circuit board or boards 74, preferably with the circuit board plane in alignment with the damper longitudinal axis 36 so the circuit board 74 is substantially vertically oriented in use with a lower end and an upper end, with the circuit board having a first accelerometer 120 and a second accelerometer 120 normal to the first, preferably with first accelerometer sensing axis 122 in alignment with the damper longitudinal axis 36 and the second accelerometer sensing axis 122 oriented perpendicular thereto. Preferably the provided upper piston rod bearing assembly 54 includes bearing holder support structure 55 which receives first upper bearing 56 and distal second lower bearing 56 to provide the piston rod bearing seal interface length BL. Preferably the upper piston rod bearing assembly 54 includes a bearing holder support structure 55 which receives at least a first bearing 56 and includes a compliance member cavity 82 for a volume compensator gas compliance member 84. Preferably the upper piston rod bearing assembly 54 includes a bearing holder support structure 55 which receives at least a first bearing 56 and includes a sensor target magnet holder 86 which receives a target magnet 88 for the magnetostrictive sensor 80 in the non-magnetic piston rod 52. Preferably the damper is dry assembled, then filled with magnetorheological fluid 40, then closed and sealed, preferably through the second lower end 58, preferably with a lower end stopper member which closes off and seal the damper and provides a lower end attachment member for attaching to the lower moving body 22,24. Preferably the piston rod 52 is hollow with an inner longitudinal chamber which includes a longitudinal magnetostrictive sensor 80, preferably with the piston rod nonmagnetic such that the permanent magnet target 88 produces a magnetic field sensed along the length of the sensor 80 and detected by the sensor head end preferably in the upper strut end head member 66. Preferably the piston rod inner longitudinal chamber includes the current supply connection circuit 100, preferably insulated wires providing connections from the current source in upper strut end head member down through rod and connected to the overmolded EM coil pins 108. Preferably the lower end of the piston rod inner longitudinal chamber is sealed off, preferably with a sealing member 98 between the lower rod end and piston head, preferably integrated with the rod and piston head attachment joint. Preferably the overmolded EM coil 94 includes an inner overmolded core receiving chamber 112, overmolded to receive a ferromagnetic core member 114, preferably with the magnetic metal core member 114 that is received in the inner overmolded core receiving chamber including an extending pole member 116 that extends out of the receiving chamber 112, preferably having an OD substantially matching the OD of the overmolded coil and the OD of the piston head, with the extending pole member 116 providing the upper magnetic pole member 96 of the piston head 44. Preferably the OD of the piston head and the overmolded coil are sized to provide the piston gap Pgap between the OD and the damper tubular housing inner wall ID. Preferably the overmolded coil includes the coil guides 95, preferably with the guides extending longitudinally along the axis 36 such that they extend over the magnetic pole members 96, with the guides 95 extending radially outward from the OD into the piston gap Pgap towards the damper tubular housing inner wall ID.

Preferably the received core member 114 includes an inner core center chamber 118 centered inside the core and extending pole member OD, the inner core center chamber 118 receiving the lower piston rod end and preferably the overmolded coil wire pin connectors 108, preferably with the sealing member 98 between the lower rod end and overmolded coil 94, preferably with the inner core center chamber and the lower piston rod end having mating attachment means, preferably such as matching threads for attaching the piston rod 52 with the piston head 44. Preferably the overmolded EM coil 94 includes a longitudinal center axis hub member 124 with the EM coil wire pins 108 and a radially extending wire coil connecting arm structure spokes (126 in FIG. 9) which provides a containment structure for the coil connection wire leads leading from the longitudinal extending wire pins 108 radially outward to the wound coil on the bobbin, and the received core member 114 includes lower end arm receiving radially extending channels 115 for receiving the extending wire coil connecting arms structure 126 including the overmold encapsulated radially extending wire leads. Preferably the overmolded coil includes the coil guides 95 centered around the axis 36 and extending longitudinally along the axis 36 such that they extend partially over an adjacent part of the magnetic pole members 96 proximate the overmolded coil, with the guides 95 extending radially outward from the OD into the piston gap Pgap towards the damper tubular housing inner wall ID, with the guide radial height from the OD sized to the piston gap dimension Pgap.

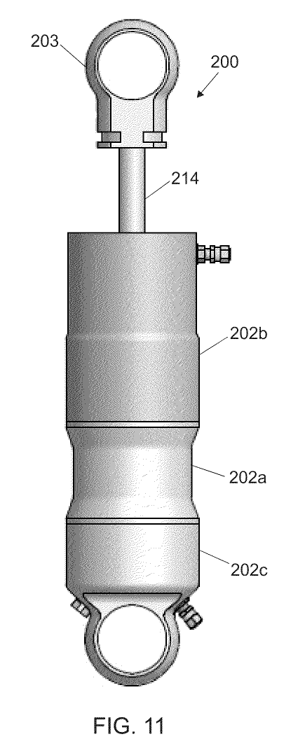

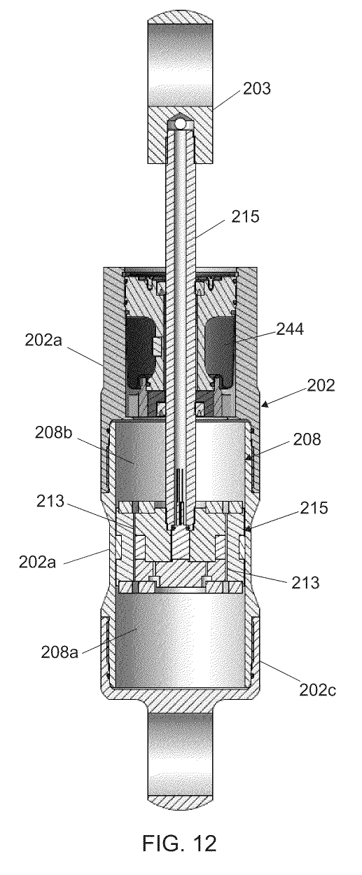

FIG. 11 depicts a magneto-rheological fluid damper 200 according to another embodiment of the invention. In the magneto-rheological fluid strut described above, the magneto-rheological fluid damper 200 may replace the previously-described magneto-rheological fluid damper (32 in FIGS. 1-10). Alternatively, the magneto-rheological fluid damper 200 may be used alone to control motion in a suspension system. For example, the magneto-rheological fluid damper 200 may be connected between the body and wheel of a vehicle, in a manner similar to that depicted for the magneto-rheological fluid strut (30 in FIGS. 1-3), as illustrated in FIG. 12. The vehicle may be a land vehicle or any other type of vehicle. The magneto-rheological fluid damper may be used in a primary vehicle suspension system or in a secondary vehicle suspension system of a vehicle, such as for the suspension system for the vehicle cab or the vehicle seat. Alternatively, the magneto-rheological fluid damper may be used in a semi-active system not coupled to a vehicle. In a primary suspension system, the magneto-rheological fluid damper would be positioned between the tire and chassis of the vehicle.

The magneto-rheological fluid damper 200 includes a damper body 202. In this example, the damper body 202 is made of several parts, including a cylinder part 202a and end caps 202b, 202c. However, these parts may be integrated to form a unitary body in alternate embodiments. The end caps 202b, 202c are coupled to distal ends of the cylinder part 202a. The cylinder part 202a is preferably a hydraulic cylinder. The cylinder part 202a contains a reservoir of magneto-rheological fluid (not shown) and a piston (not shown). The piston is coupled to a piston rod 214, which extends through the end cap 202b. The piston rod 214 extends through the end cap 202b and includes a rod end 203 for coupling to a frame or other devices.

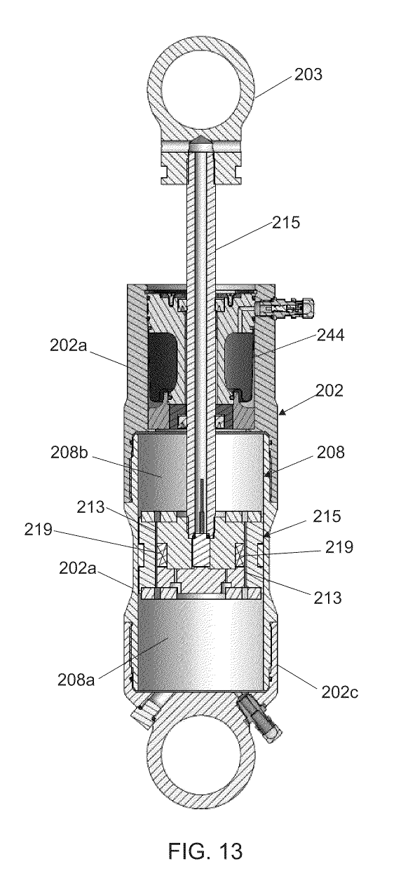

In FIGS. 12 and 13, the magneto-rheological fluid damper 200 includes a damper body 202. As in the case of the magneto-rheological fluid damper (32 in FIG. 6F), in a strut assembly, the longitudinal axis of the damper body 202 would be aligned with a strut spring, such as the longitudinal axis gas spring (64 in FIG. 6F). The damper body 202 has a hollow interior 204 in which a piston rod guide 206 is arranged. The damper body 202 may be made of a magnetic metal material, preferably a low magnetic metal material such as carbon steel. The magneto-rheological fluid damper 200 may be a monotube damper having a single reservoir 208, defined below the piston rod guide 206, for containing a magneto-rheological fluid, with the single reservoir 208 being divided by a piston 215 into a first variable volume magneto-rheological fluid damper chamber 208a and a second variable volume magneto-rheological fluid damper chamber 208b with at least one EM coil controllable magneto-rheological fluid flow conduit 213 between the first and second chambers for controlling the fluid flow (controllable current supplied to EM coil 219 produces controllable magnetic field strength for a controllable yield strength of the magneto-rheological fluid). The magneto-rheological fluid contains micron-sized magnetizable particles in a carrier fluid. Such magneto-rheological fluid is available from, for example, Lord Corporation, Cary, N.C. In one example, the magneto-rheological fluid contains iron particles and is such that the rheology of the fluid changes from a free flowing liquid to a flow resistant semi-solid with controllable yield strength when exposed to a magnetic field. In one example, the magneto-rheological fluid contains magnetizable particles having a mean particle size of about 1 micron.

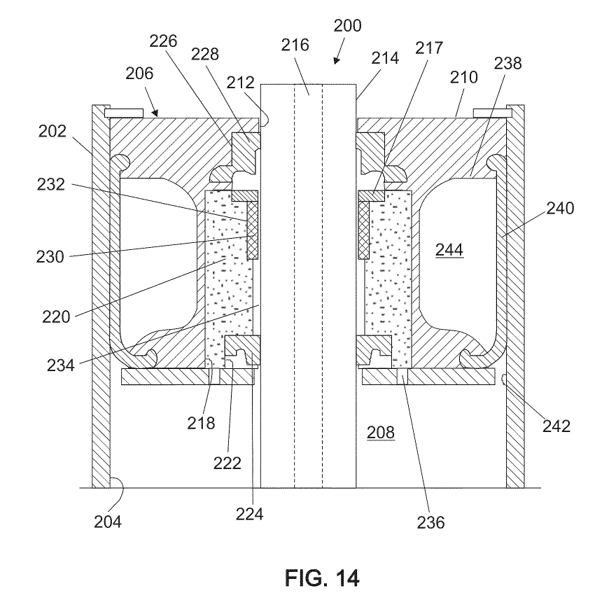

FIGS. 14-16 show an enlargement of an end portion of the magneto-rheological fluid damper 200. In comparison to the magneto-rheological fluid damper 32 in FIG. 6G, this would be the end portion including the upper piston rod bearing assembly (54 in FIG. 6G). The remaining portions of the magneto-rheological fluid damper 200 not shown may be the same as depicted in FIGS. 12 and 13, or may be as shown for the magneto-rheological fluid damper 32 in FIG. 6G.

Referring to FIG. 14, the piston rod guide 206 has an annular body 210 with a passage 212 for receiving the piston rod 214. In an embodiment the piston rod 214 is made of a nonmagnetic material, such as stainless steel. A position sensor 216 is housed within the piston rod 214. In one example, the position sensor 216 is a magnetostrictive sensor which senses stroke position of the piston along the stroke length of the damper. The position sensor 216 may communicate with an external control system or may include an internal control system. A magnetic field generator 217 may be provided proximate the piston rod 214 to create a magnetic field around the position sensor 216. The magnetic field generator 217 in one example may be a permanent magnet, which may be in the form of a ring circumscribing the piston rod 214 or position sensor 216. Alternatively, the magnetic field generator 217 may be an electromagnetic coil that is supplied with current to generate a magnetic field for the position sensor 216.

The annular body 210 includes an inner annular recess 218 circumscribing the passage 212 for receiving the piston rod 214. A filtering media 220, which may be annular in shape, is disposed within the annular recess 218. The magnetic field generator 217 described above may be included in the filtering media 220, for example, arranged in a pocket or otherwise supported on or in the filtering media 220. In one example, the filtering media 220 is made of a porous non-magnetic, corrosion-resistant material. In one example, the porous filtering media 220 has pore size less than or equal to 250 nm. In one example, the porous filtering media 220 is made of porous stainless steel having pore size less than or equal to 250 nm. The filtering media 220 includes a pocket 222 inside of which is disposed an inner piston rod seal 224. The annular body 210 includes a pocket 226 inside of which is disposed an outer piston rod seal 228. The inner and outer piston rod seals 224, 228 are arranged to engage the wall of the piston rod 214, thereby forming inner and outer seals between the piston rod guide 206 (or annular body 210) and the piston rod 214. The seals 224, 228 may be made of suitable sealing materials such as elastomeric materials.

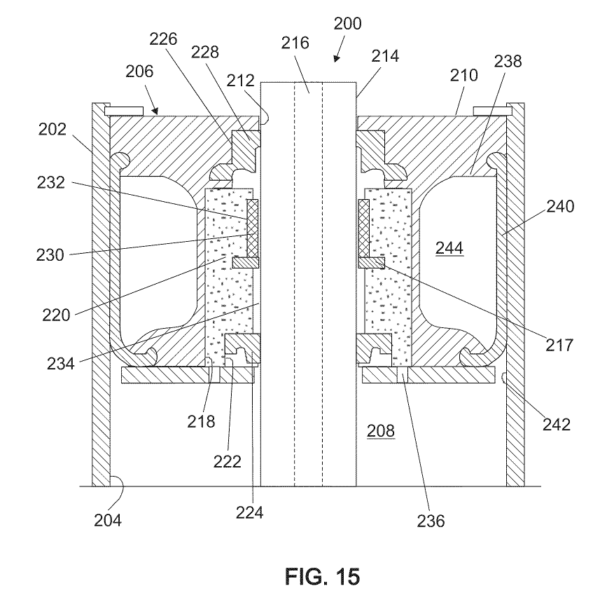

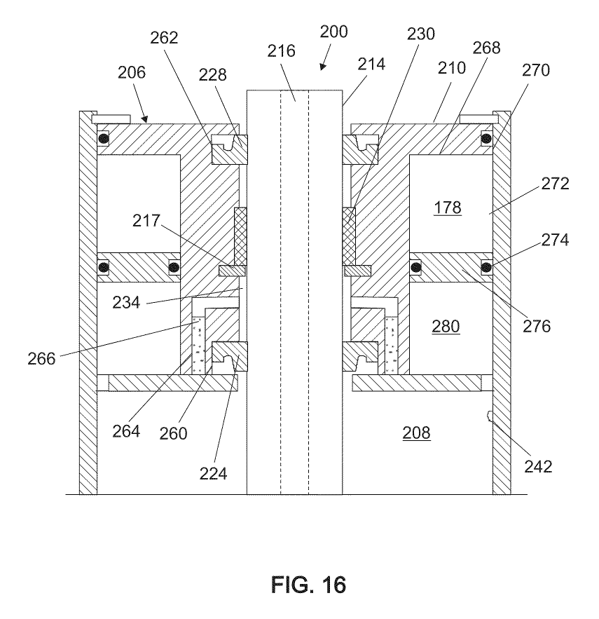

The filtering media 220 may include a pocket 230 for receiving a piston rod bearing assembly 232. When the piston rod 214 is received in the passage 212, the piston rod bearing 232 is arranged between the piston rod 214 and the filtering media 220. Further, the piston rod bearing 232 engages with and supports reciprocal motion of the piston rod 214. Any suitable piston rod bearing 232 capable of supporting reciprocal motion of the piston rod 214 may be used. For example, Glacier Garlock DU or DP-4 bearings, available from AHR International, may be used. These bearings offer a smooth low friction bearing surface and are self-lubricating. The permanent magnet 217 or other suitable magnetic field generating component may be placed above the piston rod bearing 232, as shown in FIG. 14, or may be placed between the piston rod bearing 232 and the inner seal 224, as shown in FIGS. 15 and 16.

A fluid chamber 234 is formed between the filtering media 220, the inner piston rod seal 224, the piston rod bearing 232, and the piston rod 214. The fluid chamber 234 is in communication with the reservoir 208 containing the magneto-rheological fluid. Preferably in operation, magneto-rheological fluid enters the inner annular recess 218 through ports 236 in the base of the piston rod guide 106 and flows through the filtering media 220 into the filtered fluid chamber 234. That is, the filtering media 220 is disposed in a communication path between the reservoir 108 and the fluid chamber 234. The filtering media 220 strains or filters out the magnetizable particles in the magneto-rheological fluid and allows the filtered carrier fluid to enter the fluid chamber 234. In a preferred embodiment, the permanent magnet 217 is mounted at an end of the filtering media 220 to collect magnetic particle dust left unfiltered by the filtering media 220, preferably providing magnetic filtering of magnetic particles thereby ensuring that the outer piston rod seal 228 is exposed to only filtered non-particulate clear carrier fluid. Protecting the outer seal 228 from particulates prolongs the useful life of the seal. In a preferred embodiment, the filtering media 220 inhibits the migration of magnetic particles from the inner piston rod seal 224 to the outer seal 228, with the outer seal filtered non-particulate clear carrier fluid having less than one percent of the magnetizable (iron) particle fraction of the magneto-rheological fluid contacting the inner piston rod seal 224. The filtering media 220 preferably provides a static charge pressure between the two seals 224, 228, and preferably provides that the inner seal 224 is only exposed to fluid dynamic pressure and that the outer seal 228 is only exposed to static pressure. By exposing the outer seal 228 to only static fluid pressure, air ingestion into the reservoir 108 is prevented.

The annular body 210 of the piston rod guide 206 further includes an outer annular recess 238. A diaphragm or bladder 240 is mounted in the outer annular recess 238 and abuts an inner wall 242 of the damper body 202 of the damper body 202. The diaphragm 240 defines an air-volume which functions as an accumulator 242. In use, the accumulator 244 is charged with an inert gas such as nitrogen. Although not shown, a port may be provided in the inner wall 242 of the damper body 202 or in the annular body 210 through which gas can be supplied into the accumulator 244. The diaphragm 240 is exposed to the magneto-rheological fluid in the reservoir 208 through a gap between the annular body 210 of the piston rod guide 206 and the inner wall 242 of the damper body 202. The accumulator 242 serves to minimize pressure transients in the magneto-rheological fluid in the reservoir 208, thereby minimizing the risk of cavitation or negative pressure. Thus, the accumulator 244 minimizes pressure transients while the porous filter media 220 filters out pressure transients from the outer piston rod seal 228. The combined effect is low charge pressures, e.g., on the order of 200 to 300 psig, without risk of air ingestion and with minimal risk of cavitation. Preferably the piston rod guide 206 includes and houses an accumulator, preferably a gas charged accumulator.

FIG. 16 shows an alternative example of the magneto-rheological fluid damper 200. In this example, the annular body 210 of the piston rod guide 206 includes inner annular recesses 260, 262, which hold inner piston rod seal 224 and outer piston rod seal 228, respectively. This embodiment includes the piston rod guide 206 with a gas charged accumulator. A fluid conduit or passage 264 extends from the base of the annular body 210 and terminates in an inner surface 266 of the annular body 210 adjacent to the piston rod 214. A filtering media 266, having properties described for the filtering media 220 (FIGS. 14 and 15) above, is disposed in the passage 264 to filter magnetizable particles from fluid entering the fluid chamber 234 defined between the piston rod 214, the inner surface 216 of the annular body 210, and the seals 224, 228. In this example, the annular body 210 includes an outer annular recess 268 which is open at the outer surface 270 of the annular body 210. The outer surface 270 of the annular body 210 abuts the inner wall 242 of the damper body 202, thereby defining a chamber 272, which serves as an accumulator. A piston 274 is disposed in the chamber 272 and can slide within the chamber 272 in response to pressure differential across it. The piston 274 includes sealing members 276, which engage an inner wall 278 of the annular body 210 and the inner wall 242 of the damper body 202, thereby partitioning the chamber 272 into a gas chamber 278 and a magneto-rheological fluid chamber 280. The gas chamber 278 may be filled with an inert gas such as nitrogen. Although not shown, a port may be provided in the damper body 202 or annular body 210 through which gas can be supplied to the gas chamber 278. The magneto-rheological fluid chamber 280 is in communication with the reservoir 208 through a gap between the base of the annular body 210 and the inner wall 242 of the damper body 202 or through ports in the base of the annular body 210. The accumulator provided by the chamber 272 and piston 274 serves the same purpose as described for the accumulator 244 (FIGS. 14 and 15) above. Preferably the piston rod guides include and house a gas charged accumulator, preferably between the piston rod 214 and the damper body 202, and preferably proximate the seal 224.

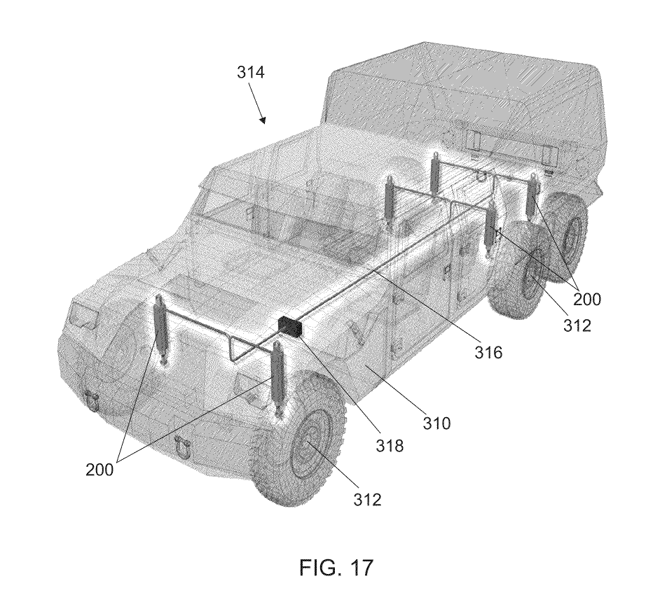

FIG. 17 depicts an exemplary vehicle 314 with magneto-rheological fluid dampers 200 between the body 310 and the wheels 312 of the vehicle. The magneto-rheological fluid dampers 200 are in communication with a suspension control system 316 including a control unit 318. In one example, the control unit 318 receives sensor signals from sensors, which may reside in the dampers 200, on the vehicle 314 and calculates forces at the dampers 200. These desired force values are converted and amplified into current, e.g., via closed loop current control, to the dampers 200. In one example, the sensors (not shown) are accelerometers, and the control unit 318 receives signals from the accelerometers and uses those signals to calculate forces at the dampers 200. In a preferred embodiment, five or six accelerometers are arranged in different locations and orientations in the vehicle in order to provide the sensor signals to the control unit 318. In another example, the sensors include accelerometers and roll-rate sensors, and the control unit 318 receives signals from the accelerometers and roll-rate sensors and uses those signals to calculate forces at the dampers 200. In a preferred embodiment, three accelerometers and two roll-rate sensors are arranged in different locations in the vehicle in order to provide the sensor signals to the control unit 318. The vehicle 314 in preferred embodiments is a land vehicle, preferably a wheeled land vehicle which preferably transports variable payloads over varied land conditions, such as a truck or off-road vehicle, as shown in FIG. 17, or may be another type of vehicle. In preferred embodiments the magneto-rheological fluid dampers are primary vehicle suspension magneto-rheological fluid dampers in the primary suspension of the vehicle between the vehicle body 310 and the wheels 312. In alternative embodiments the magneto-rheological fluid dampers are secondary vehicle suspension magneto-rheological fluid dampers in the secondary suspension systems of vehicles, such as for the suspension system for the vehicle cab or the vehicle seat. Alternatively, the magneto-rheological fluid dampers 200 may be used in a semi-active suspension system that is not coupled to a vehicle.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

We claim:

1. A controllable suspension system for controlling the relative motion between a first body and a second body, said controllable suspension system including at least one strut, said at least one strut including a magneto-rheological fluid damper, said magneto-rheological fluid damper comprising:
a damper body;
a piston rod guide disposed within the damper body, the piston rod guide having a passage therein for receiving a piston rod;
a piston rod bearing assembly disposed in the piston rod guide to engage with and support reciprocal motion of the piston rod;
at least a first piston rod seal and at least a second piston rod seal arranged to seal between the piston rod guide and the piston rod;
a fluid chamber defined between the piston rod guide and the piston rod; and
a piston rod guide gas charged accumulator arranged between the piston rod and the damper body.

2. The controllable suspension system of claim 1, wherein said magneto-rheological fluid damper further comprises a reservoir for a magneto-rheological fluid provided within the damper body.

3. The controllable suspension system of claim 2, wherein said magneto-rheological fluid damper further comprises a piston rod guide filter arranged in a communication path between the fluid chamber and the reservoir to filter particulates out of the magneto-rheological fluid entering the fluid chamber.

4. The controllable suspension system of claim 3, wherein the piston rod guide includes a fluid conduit in communication with the reservoir.

5. The controllable suspension system of claim 4, wherein the piston rod guide filter is disposed in the fluid conduit.

6. The controllable suspension system of claim 1, wherein the fluid chamber is defined between the at least first and second piston rod seals.

7. The controllable suspension system of claim 1, wherein said magneto-rheological fluid damper further comprises a piston rod guide filter arranged to filter out particulates from fluid entering the fluid chamber.

8. The controllable suspension system of claim 1, wherein the accumulator comprises a diaphragm.

9. The controllable suspension system of claim 1, wherein the accumulator comprises a gas charged piston.

10. The controllable suspension system of claim 1, wherein the piston rod guide filter includes a magnetic field generator.

11. The controllable suspension system of claim 10, wherein the magnetic field generator is a permanent magnet.

12. The controllable suspension system of claim 1, wherein said magneto-rheological fluid damper further comprises a piston coupled to the piston rod.

13. The controllable suspension system of claim 1, wherein said strut includes a longitudinal gas spring aligned with said damper body.

14. The controllable suspension system of claim 1, which is a controllable vehicle suspension system.

15. A controllable suspension system for controlling the relative motion between a first body and a second body, said controllable suspension system comprising:
a damper body;
a spring longitudinally aligned with the damper body;
a piston rod guide disposed within the damper body, the piston rod guide having a passage therein for receiving a piston rod;
a piston rod bearing assembly disposed in the piston rod guide to engage with and support reciprocal motion of the piston rod;
at least a first piston rod seal and at least a second piston rod seal arranged to seal between the piston rod guide and the piston rod;
a fluid chamber defined between the piston rod guide and the piston rod; and
a piston rod guide gas charged accumulator, said piston rod guide gas charged accumulator arranged between the piston rod and the damper body.

16. A controllable suspension system for controlling the relative motion between a first body and a second body, said controllable suspension system including at least one strut, said at least one strut including a magneto-rheological fluid damper, said magneto-rheological fluid damper comprising:
a damper body;
a piston rod guide disposed within the damper body, the piston rod guide having a passage therein for receiving a piston rod;
a piston rod bearing assembly disposed in the piston rod guide to engage with and support reciprocal motion of the piston rod;
at least a first piston rod seal and at least a second piston rod seal arranged to seal between the piston rod guide and the piston rod;
a fluid chamber defined between the piston rod guide and the piston rod;
means for filtering fluid entering the fluid chamber; and
a piston rod guide gas charged accumulator arranged between the piston rod guide and the damper body.

17. The controllable suspension system of claim 16, wherein the piston rod guide includes a fluid conduit, and wherein the filtering means is disposed in the fluid conduit.

18. A method of making a controllable suspension system for controlling the relative motion between a first body and a second body, said method comprising:
providing a magneto-rheological fluid;
providing a damper body having a reservoir for containing the magneto-rheological fluid;
providing a piston rod;
providing a piston rod guide disposed within the damper body, the piston rod guide having a passage therein for receiving the piston rod;
providing a piston rod assembly coupled to the piston rod guide and arranged to engage and support reciprocal motion of the piston rod;
providing at least a first piston rod seal and at least a piston rod seal arranged to seal between the piston rod guide and the piston rod;
providing a fluid chamber defined between the piston rod guide and the piston rod;
providing a piston rod guide filter arranged in a communication path between the fluid chamber and the reservoir to filter particulates out of fluid entering the fluid chamber; and
providing an accumulator arranged between the piston rod guide and the damper body.

19. The method of claim 18, further comprising providing a spring longitudinally aligned with the damper body.

20. A controllable suspension system for controlling the relative motion between a first body and a second body, said controllable suspension system including at least one magneto-rheological fluid damper, said magneto-rheological fluid damper comprising:
a damper body;
a piston rod guide disposed within the damper body, the piston rod guide having a passage therein for receiving a piston rod;
a piston rod bearing assembly disposed in the piston rod guide to engage with and support reciprocal motion of the piston rod;
at least a first piston rod seal and at least a second piston rod seal arranged to seal between the piston rod guide and the piston rod;
a fluid chamber defined between the piston rod guide and the piston rod; and
a piston rod guide gas charged accumulator arranged between the piston rod and the damper body;
said magneto-rheological fluid damper including a reservoir for a magneto-rheological fluid provided within the damper body, and a piston rod guide filter arranged in a communication path between the fluid chamber and the reservoir to filter particulates out of the magneto-rheological fluid entering the fluid chamber from the reservoir.

21. The controllable suspension system of claim 20, wherein the piston rod guide includes a fluid conduit in communication with the reservoir.

22. The controllable suspension system of claim 20, wherein the piston rod guide filter includes a filtering media disposed in a fluid conduit.

23. The controllable suspension system of claim 20, wherein the fluid chamber is defined between the at least first and second piston rod seals.

24. The controllable suspension system of claim 20, wherein the accumulator comprises a diaphragm.

25. The controllable suspension system of claim 20, wherein the accumulator comprises a gas charged piston.

26. The controllable suspension system of claim 20, wherein the piston rod guide filter includes a magnetic field generator.

27. The controllable suspension system of claim 26, wherein the magnetic field generator is a permanent magnet.

28. The controllable suspension system of claim 20, including a longitudinal gas spring aligned with said damper body.

29. The controllable suspension system of claim 20, which is a controllable land vehicle suspension system.

30. A vehicle suspension system for controlling the relative motion between a first body and a second body, said suspension system comprising:
a damper body;
a spring longitudinally aligned with the damper body;
a piston rod guide disposed within the damper body, the piston rod guide having a passage therein for receiving a piston rod;
a piston rod bearing assembly disposed in the piston rod guide to engage with and support reciprocal motion of the piston rod;
at least a first piston rod seal and at least a second piston rod seal arranged to seal between the piston rod guide and the piston rod;
a fluid chamber defined between the piston rod guide and the piston rod;
a piston rod guide gas charged accumulator, said piston rod guide gas charged accumulator arranged between the piston rod and the damper body; and
a piston rod guide filter.

31. A method of controlling motion between a first body and a second body, said method comprising:
providing a magneto-rheological damper fluid comprised of a plurality of magnetic particulates in a carrier fluid;
providing a damper body having a reservoir for containing the magneto-rheological fluid;
providing a piston rod;
providing a piston rod guide disposed within the damper body, the piston rod guide having a passage therein for receiving the piston rod;
providing a piston rod assembly coupled to the piston rod guide and arranged to engage and support reciprocal motion of the piston rod;
providing at an outer piston rod seal arranged to seal against the piston rod;
providing a piston rod guide accumulator arranged between the piston rod and the damper body; and
inhibiting the magnetic particulates from the magneto-rheological fluid in the reservoir from reaching the outer piston rod seal.

32. The method of claim 31, wherein inhibiting magnetic particulates from the magneto-rheological fluid in the reservoir from reaching the outer piston rod seal includes filtering out the magnetic particulates from the carrier fluid.

33. The method of claim 32, wherein the filtered carrier fluid contacts the outer piston rod seal.

34. The method of claim 31, further comprising providing a spring longitudinally aligned with the damper body.
